(19) United States
(12) Patent Application Publication
(10) Pub. No.: US 2026/0089230 A1
(43) Pub. Date: Mar. 26, 2026

(54) PRESENCE COMMUNICATION AND ASSOCIATED SYSTEMS, METHODS, AND NON-TRANSITORY COMPUTER-READABLE MEDIA

(71) Applicant: 360 World, Inc., Newark, CA (US)

(72) Inventor: Dinanath Jiut Gupt, Fremont, CA (US)

(73) Assignee: 360 World, Inc., Newark, CA (US)

(21) Appl. No.: 19/337,805

(22) Filed: Sep. 23, 2025

Related U.S. Application Data
(60) Provisional application No. 63/765,422, filed on Feb. 28, 2025.
(60) Provisional application No. 63/741,378, filed on Jan. 2, 2025.
(60) Provisional application No. 63/730,408, filed on Dec. 10, 2024.
(60) Provisional application No. 63/714,312, filed on Oct. 31, 2024.
(60) Provisional application No. 63/697,948, filed on Sep. 23, 2024.

(51) Int. Cl. H04L 67/54; H04L 9/40; H04L 51/043; H04W 4/021

(52) U.S. Cl. CPC H04L 67/54; H04L 51/043; H04L 63/0457; H04W 4/021

(57) ABSTRACT

An example method includes receiving multiple first availabilities and multiple first locations from multiple first presence communication clients. At least some of the multiple first availabilities and the multiple first locations are provided to a second presence communication client. A first request for one or more services at a particular location is received from the second presence communication client. Based on the first request, one or more first presence communication clients are identified and a particular first presence communication client is selected. A second request to establish a presence communication with the second presence communication client is transmitted to a particular first presence communication client. An acceptance of the second request is received from the particular first presence communication client. The presence communication between the particular first presence communication client and the second presence communication client is established.

### CROSS-REFERENCE TO RELATED APPLICATIONS

This application claims priority to and seeks the benefit of U.S. Provisional Patent Application No. 63/697,948, filed on September 23, 2024, and entitled “PLATFORM FOR SERVICES EXCHANGES BETWEEN USERS,” U.S. Provisional Patent Application No. 63/714,312, filed on October 31, 2024, and entitled “LOCATION AS A SKILL OR SERVICE,” U.S. Provisional Patent Application No. 63/730,408, filed on December 10, 2024, and entitled “CONVERSION OF TIME INTO UTILITY AND UTILITY INTO TIME ON A PLATFORM FOR SERVICES EXCHANGES BETWEEN USERS,” U.S. Provisional Patent Application No. 63/741,378, filed on January 2, 2025, and entitled “CONNECTING USERS PROVIDING SUPPLEMENTARY OR COMPLEMENTARY INFORMATION TO CHATBOT RESPONSES AND OTHER INFORMATION,” and U.S. Provisional Patent Application No. 63/765,422, filed on February 28, 2025, and entitled “REMOTE GUIDE SERVICES ON A PLATFORM FOR SERVICES EXCHANGES BETWEEN USERS.” Each of the foregoing applications is incorporated by reference herein in its entirety.

### TECHNICAL FIELD

The present disclosure relates in general to communication systems, and in particular to presence communication systems that allow persons to connect to each other for purposes such as providing or receiving services.

### BACKGROUND

Conventional communication systems allow two persons to connect to each other and provide the same features (for example, video, voice, messaging) to each person. However, conventional communication systems do not allow a person to find another person who is not known to the searching person, based on a location. Moreover, conventional communication systems do not allow for asymmetrical communication between persons, allow the persons to communicate using gesture instructions, or revise messages between the persons to eliminate or reduce negative or undesired messages.

### SUMMARY

In some aspects, the techniques described herein relate to a method including: receiving, from multiple first presence communication clients, multiple first availabilities and multiple first locations; providing at least some of the multiple first availabilities and the multiple first locations to a second presence communication client; receiving, from the second presence communication client, a first request for one or more services at a particular location; identifying, based on the first request, one or more first presence communication clients from the multiple first presence communication clients; selecting, from the one or more first presence communication clients, a particular first presence communication client; transmitting to the particular first presence communication client a second request to establish a presence communication with the second presence communication client; receiving from the particular first presence communication client an acceptance of the second request; and establishing the presence communication between the particular first presence communication client and the second presence communication client, wherein, during the presence communication, only the particular first presence communication client transmits video to the second presence communication client, the second presence communication client may transmit instructions from a limited set of instructions to the particular first presence communication client, and the particular first presence communication client may transmit responses from a limited set of responses to the second presence communication client.

In some aspects, the techniques described herein relate to a method wherein the presence communication is a first presence communication, the particular first presence communication client is a first particular first presence communication client, the acceptance is a first acceptance, and further including: determining that the particular first presence communication client has ended the first presence communication; selecting, from the one or more first presence communication clients, a second particular first presence communication client; transmitting to the second particular first presence communication client a third request to establish a second presence communication with the second presence communication client; receiving from the second particular first presence communication client a second acceptance of the third request; and establishing the second presence communication between the second particular first presence communication client and the second presence communication client.

In some aspects, the techniques described herein relate to a method wherein the second presence communication client has an association with the particular first presence communication client that was created prior to the presence communication.

In some aspects, the techniques described herein relate to a method wherein the presence communication includes video captured by the particular first presence communication client, a portion of the video encrypted by the particular first presence communication client, transmitted by the particular first presence communication client to the second presence communication client, and displayed by the second presence communication client after decryption of the portion of the video.

In some aspects, the techniques described herein relate to a method wherein the presence communication further includes one or more first instructions from the limited set of instructions received by the second presence communication client, transmitted by the second presence communication client to the particular first presence communication client, and the particular first presence communication client generates, based on the one or more first instructions, one or more second instructions, and outputs the one or more second instructions.

In some aspects, the techniques described herein relate to a method, further including: storing a start and an end of the presence communication; determining, based on the start and the end of the presence communication, a first amount to credit a first account associated with a first user of the particular first presence communication client and a second amount to debit a second account associated with a second user of the second presence communication client; crediting the first account by the first amount; and debiting the second account by the second amount.

In some aspects, the techniques described herein relate to one or more non-transitory computer-readable media including executable instructions that when executed by one or more processors of a system cause the system to perform a method including: receiving, from multiple first presence communication clients, multiple first availabilities and multiple first locations; providing at least some of the multiple first availabilities and the multiple first locations to a second presence communication client; receiving, from the second presence communication client, a first request for one or more services at a particular location; identifying, based on the first request, one or more first presence communication clients from the multiple first presence communication clients; selecting, from the one or more first presence communication clients, a particular first presence communication client; transmitting to the particular first presence communication client a second request to establish a presence communication with the second presence communication client; receiving from the particular first presence communication client an acceptance of the second request; and establishing the presence communication between the particular first presence communication client and the second presence communication client, wherein, during the presence communication, only the particular first presence communication client transmits video to the second presence communication client, the second presence communication client may transmit instructions from a limited set of instructions to the particular first presence communication client, and the particular first presence communication client may transmit responses from a limited set of responses to the second presence communication client.

In some aspects, the techniques described herein relate to one or more non-transitory computer-readable media wherein the presence communication is a first presence communication, the particular first presence communication client is a first particular first presence communication client, the acceptance is a first acceptance, and the method further including: determining that the particular first presence communication client has ended the first presence communication; selecting, from the one or more first presence communication clients, a second particular first presence communication client; transmitting to the second particular first presence communication client a third request to establish a second presence communication with the second presence communication client; receiving from the second particular first presence communication client a second acceptance of the third request; and establishing the second presence communication between the second particular first presence communication client and the second presence communication client.

In some aspects, the techniques described herein relate to one or more non-transitory computer-readable media wherein the second presence communication client has an association with the particular first presence communication client that was created prior to the presence communication.

In some aspects, the techniques described herein relate to one or more non-transitory computer-readable media wherein the presence communication includes video captured by the particular first presence communication client, a portion of the video encrypted by the particular first presence communication client, transmitted by the particular first presence communication client to the second presence communication client, and displayed by the second presence communication client after decryption of the portion of the video.

In some aspects, the techniques described herein relate to one or more non-transitory computer-readable media wherein the presence communication further includes one or more first instructions from the limited set of instructions received by the second presence communication client, transmitted by the second presence communication client to the particular first presence communication client, and the particular first presence communication client generates, based on the one or more first instructions, one or more second instructions, and outputs the one or more second instructions.

In some aspects, the techniques described herein relate to one or more non-transitory computer-readable media, the method further including: storing a start and an end of the presence communication; determining, based on the start and the end of the presence communication, a first amount to credit a first account associated with a first user of the particular first presence communication client and a second amount to debit a second account associated with a second user of the second presence communication client; crediting the first account by the first amount; and debiting the second account by the second amount.

In some aspects, the techniques described herein relate to a system including: multiple first presence communication clients configured to transmit multiple first availabilities and multiple first locations; a second presence communication client; and a presence communication server configured to: receive the multiple first availabilities and the multiple first locations, and provide at least some of the multiple first availabilities and the multiple first locations to the second presence communication client, wherein the second presence communication client is configured to: receive at least some of the multiple first availabilities and the multiple first locations, and transmit a first request for one or more services at a particular location, the presence communication server is further configured to: receive the first request for the one or more services at the particular location, identify, based on the first request, one or more first presence communication clients from the multiple first presence communication clients, select, from the one or more first presence communication clients, a particular first presence communication client, transmit to the particular first presence communication client a second request to establish a presence communication with the second presence communication client, receive from the particular first presence communication client an acceptance of the second request, and establish the presence communication between the particular first presence communication client and the second presence communication client, and the particular first presence communication client is configured to: capture video; and transmit the video to the second presence communication client, wherein, during the presence communication, only the particular first presence communication client captures video and transmits the video to the second presence communication client, the second presence communication client is further configured to transmit instructions from a limited set of instructions to the particular first presence communication client, and the particular first presence communication client is further configured to transmit responses from a limited set of responses to the second presence communication client.

In some aspects, the techniques described herein relate to a system wherein the second presence communication client is further configured to: receive the video, display the video, receive, via a gesture user interface, one or more first instructions from the limited set of instructions, and transmit the one or more first instructions to the particular first presence communication client, and the particular first presence communication client is further configured to: receive the one or more first instructions, generate, based on the one or more first instructions, one or more second instructions, and output the one or more second instructions.

In some aspects, the techniques described herein relate to a system wherein the particular first presence communication client is associated with a language, to generate the one or more second instructions includes to generate the one or more second instructions in the language, and to output the one or more second instructions includes to audibly output the one or more second instructions in the language.

In some aspects, the techniques described herein relate to a system wherein the particular first presence communication client is configured to: capture video, the video including a product, and transmit the video to the second presence communication client, the second presence communication client is further configured to: receive the video, display the video, receive a selection of the product, transmit a query for the product, receive results for the query, and display at least some of the results, and the particular first presence communication client is further configured to: receive the results, and display at least some of the results.

In some aspects, the techniques described herein relate to a system wherein the presence communication includes video, and the particular first presence communication client is configured to: receive a selection of a portion of the video to blur, blur the portion of the video, and transmit the video, including the portion of the video that is blurred or a blurred representation of the portion of the video, to the second presence communication client, and the second presence communication client is further configured to: receive the video, including the portion of the video that is blurred or a blurred representation of the portion of the video, and display the video, including the portion of the video that is blurred or the blurred representation of the portion of the video.

In some aspects, the techniques described herein relate to a system wherein the particular first presence communication client is configured to transmit a first message to the second presence communication client, and the second presence communication client is further configured to: receive the first message, provide the first message for processing by one or more artificial intelligence or machine learning systems, receive a second message, based on processing of the first message by the one or more artificial intelligence or machine learning systems, and output the second message.

In some aspects, the techniques described herein relate to a system wherein the particular first presence communication client is configured to: capture video, the video including an item, determine that the item should be blurred in the video, blur the item in the video or generate a blurred representation of the item, generate a first identifier for the item, and transmit the video, including the item that is blurred, or the blurred representation of the item, and the first identifier to the second presence communication client, and the second presence communication client is further configured to: receive the video, including the item that is blurred, or the blurred representation of the item, and the first identifier, determine that the first identifier matches a second identifier stored by the second presence communication client, and unblur the item that is blurred in the video or the blurred representation of the item, and display the video, including the item.

In some aspects, the techniques described herein relate to a system wherein the item that is blurred includes a part of a person or other identifiable information of the person.

### BRIEF DESCRIPTION OF THE DRAWINGS

FIG. 1 depicts an example environment in which a presence communication system according to some embodiments may operate.

FIG. 2 is a block diagram depicting components of the presence communication system in some embodiments.

FIG. 3 is a swimlane diagram depicting interactions between different parts of the presence communication system and other systems according to some embodiments.

FIGS. 4A-4F depict example interfaces that may be provided by presence communication clients in some embodiments.

FIGS. 5A and 5B depict other example interfaces that may be provided by presence communication clients according to some embodiments.

FIGS. 6A and 6B depict other example interfaces that may be provided by presence communication clients in some embodiments.

FIGS. 7A-7D depict other example interfaces that may be provided by presence communication clients according to some embodiments.

FIG. 8 depicts another example interface that may be provided by a presence communication client in some embodiments.

FIG. 9 depicts communication between two presence communication clients according to some embodiments.

FIGS. 10 and 11 depict example interfaces that may be provided by a presence communication server to provide analytic outputs relating to presence communications or the presence communication system in some embodiments.

FIGS. 12 and 13 depict example interfaces that may be provided by the presence communication server to provide functionality relating to managing affiliates and managing business accounts according to some embodiments.

FIG. 14 depicts a block diagram of an example digital device according to various embodiments.

FIG. 15 is a flow diagram depicting a method for establishing a presence communication in some embodiments.

FIG. 16 is a flow diagram depicting a method for encrypting video in some embodiments.

Throughout the drawings, like reference numerals will be understood to refer to like parts, components, and structures.

### DETAILED DESCRIPTION

Described herein is a presence communication system that may allow any person in the world to communicate with any other person in the world. The presence communication system may limit the features or functionality of presence communication clients that persons use to preserve the persons’ privacy and security. For example, the presence communication system may allow only one person to transmit video to the other person, and may not allow voice communication between the two persons. As another example, the presence communication system may allow the person receiving video to send instructions using only a limited set of instructions to the person transmitting video, who may respond to the instructions using only a limited set of responses. As another example, the presence communication system may allow the persons to send messages to each other, but may analyze the messages to reduce or eliminate negative or unwanted messages.

The presence communication system may allow any two persons to communicate with each other, regardless of the persons’ ages, locations, or language capabilities. For example, two persons who speak two different languages may be able to communicate despite not knowing or understanding each other’s languages. The presence communication system may allow for such communication to occur by provider interfaces that may be universally or near-universally understood and by outputting instructions or responses in the languages of the persons. The presence communication system may also output instructions or responses that are customized to the cultures of the persons so that the persons may have positive experiences. As the two persons may not know each other, the presence communication system may allow the two persons to communicate anonymously or pseudonymously.

The presence communication system may allow users to unlock and monetize their time, experiences, skills or locations by structuring the provision of their time, experience, skills or locations to other users. A user of the presence communication system who provides his or her time, experiences, skills or locations may be referred to as a provider. A user of the presence communication system who requests that time, an experience, a skill, or a location be provided to him or her may be referred to as a consumer. An experience, a skill, or a location may be referred to herein as a service.

The presence communication system may track providers’ locations and availabilities and provide the locations and availabilities to consumers. A consumer who wishes to obtain a service at a location may search for providers by the location, either by using a map interface or using search queries. The consumer may thus be able to locate providers anywhere in the world. The presence communication system may identify providers based on the location, select a provider, and establish a presence communication between the selected provider and the consumer. The presence communication system may facilitate users being offered services opportunities and providing services that are based on the users’ locations. The presence communication system may suggest or recommend services that users may provide based on the users’ locations so that the users may provide such services.

Certain presence communications may differ between a conventional communication in one or more of several ways. First, only the provider may capture and transmit video to the consumer in certain presence communications. Second, the consumer may be able to transmit instructions to the provider using only a limited set of instructions, such as to tell the provider to move in one or more directions, and the provider may be able to respond to such instructions using only a limited set of responses. Third, any messages between the provider and the consumer may be revised by the presence communication system to modify an intention, tone, substance, or words of the messages, which may assist in reducing or eliminating negative or unwanted messages. These differences may make certain presence communications be asymmetrical, as opposed to conventional communication systems, which provide symmetrical features and functionality to each participant.

The presence communication system may provide the following functionality and/or features: user onboarding and validation (for example, an active user vouching for and/or certifying a new user joining the presence communication system); data collection from users (for example, user skills, experiences, locations, and/or services and/or pricing); matching of user needs and/or requests to user capabilities (for example, based on services and/or availability); caching of user data for rapid matching (for example, to allow for rapid querying for services); frequency matching of users requesting services with users providing services (for example, based on similar backgrounds, temperaments, abilities and/or other affinity factors); facilitating provision of services taking into account trust extended by a user requesting a service to a user providing the service (for example, a first user trusting second users to which the first user may be separated by more than one degree of separation); and ranking and/or prioritization of users providing services.

The presence communication system may also allow for users to provide and receive services anonymously or pseudonymously, so as to preserve user privacy. The presence communication system may provide transactions support to users, delivering to them services pricing discovery, contracting tools, performance verification, in kind or bartering transaction support, and rational structuring for novel transaction types. The presence communication system may support promotion-supported services delivery, such as a real time online event featuring one or a handful of services providers and services recipients who sign up in advance to participate in that event. The presence communication system may provide payment functionality (for example, real currency, virtual currency and/or credits) to facilitate payments for providing services and may also provide fungibility guidance and value normalization for users bartering services amongst each other. The presence communication system may provide communication functionality to allow users to communicate with each other using text, audio, images, video and other modalities, either asynchronously or in real time. The presence communication system may also translate requests and/or services so that users of different languages and/or cultures may communicate with each other (for example, the presence communication system may provide real-time translation of text or voice communications).

The presence communication system may also provide for users to provide services and/or monetize their skills based primarily on users’ locations, especially locations where users may be situated for limited periods of time. The presence communication system may have real-time knowledge of users’ locations and/or users’ availabilities. The presence communication system may facilitate users being offered services opportunities and providing services that are based on the users’ locations. The presence communication system may suggest or recommend services that users may provide based on the users’ locations so that the users may provide such services. The presence communication system may automatically match a user seeking services with a user providing services based on attributes known about each user. The presence communication system may allow for service exchanges in areas such as real estate, travel, communications, entertainment, education, e-commerce, healthcare, and in other basic or professional services areas.

The presence communication system may support devices and tools without interactive interfaces or with limited interactive interfaces, such as a device that may broadcast a request for services to multiple providing users. For example, a user may have one or more associated user accounts that the user may control by specifying the services available to the associated user accounts, the services that the associated user accounts may provide, and the users with whom the associated users may interact. As an example, the user may be a parent, and the one or more associated users may be one or more children of the parent.

An associated user may have a device with a user interface that allows the associated user to broadcast a request for services, such as an emergency request for assistance, to other users. The presence communication system may allow the user to specify the other users from whom the associated user may request emergency assistance. Additionally or alternatively, the presence communication system may broadcast the request for emergency assistance to available users who are within a defined distance from the associated user.

The presence communication system may be made available as a service to other businesses wishing to provide real-time location services capabilities or other services capabilities to their own users. For example, the presence communication system may allow businesses to enroll requesting users. The presence communication system may permit the businesses to specify the services that requesting users may request and/or the providing users who may provide services to the requesting users. The presence communication system may also be made available as a service to other businesses that wish to provide services to users of the presence communication system. For example, the presence communication system may allow businesses to enroll providing users, to specify the services of providing users, and to specify who may request services from the providing users.

The presence communication system may provide one or more application programming interfaces (APIs) that other businesses may use to interact with the presence communication system to achieve such functionality. Other businesses may utilize the one or more APIs to, for example, enroll users who may provide services, specify services of providing users, specify services of requesting users, and specify requesting users. The one or more APIs may facilitate additional functionality.

The presence communication system offers numerous advantages. One advantage is that the provider and the consumer need not speak the same language, as the presence communication system may provide interfaces and outputs in each’s own language. Another advantage is that by constraining instructions and responses and by reducing or eliminating negative or unwanted messages, the presence communication system may be utilized by persons who should not or may not want to be exposed to negative or unwanted experiences. Yet another advantage is that the presence communication system allows providers to monetize their time, experiences, skills or locations by earning revenue for providing their time, experiences, skills or locations, and for consumers to obtain services that they may not otherwise be able to obtain. Other advantages will be apparent.

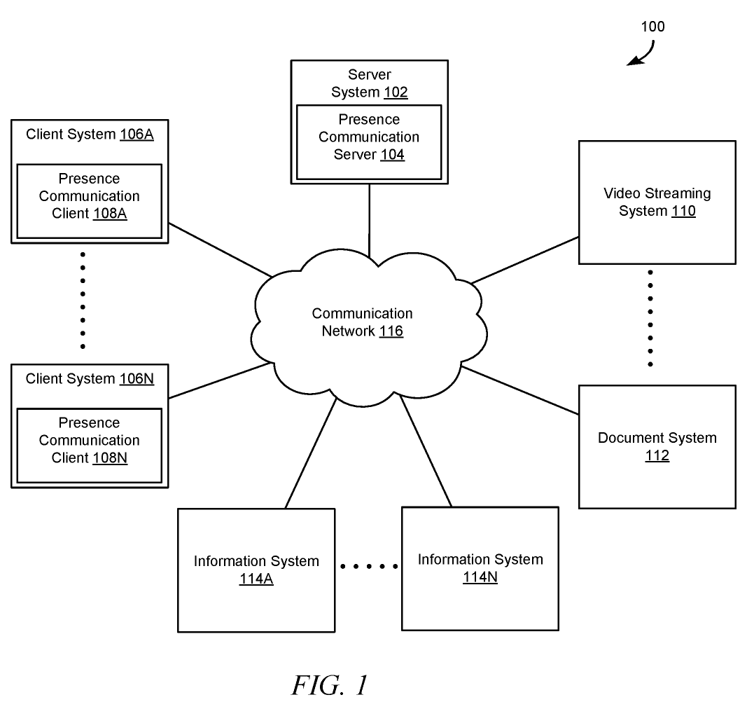

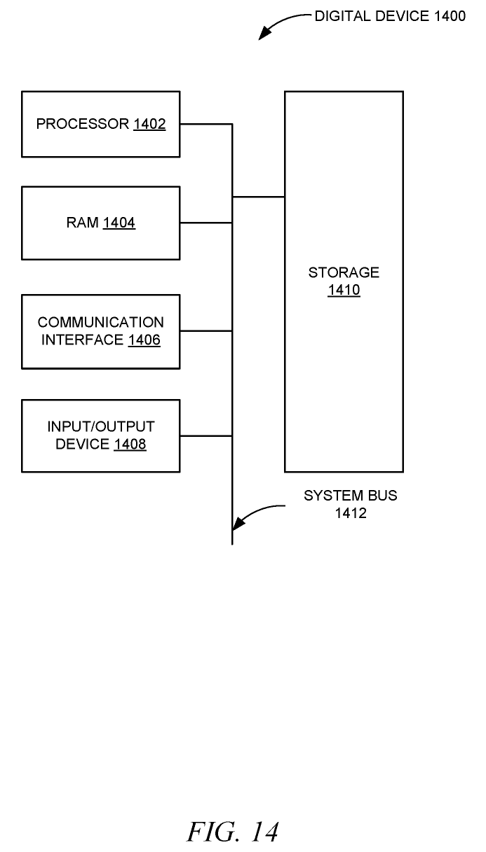

FIG. 1 depicts an example environment 100 in which a presence communication system according to some embodiments may operate. The environment 100 includes a server system 102, multiple client systems 106A through 106N (which may be referred to as a client system 106 or as client systems 106), a video streaming system 110, a document system 112, information systems 114A through 114N (which may be referred to as an information system 114 or as information systems 114), and a communication network 116. Each of the server system 102, the client systems 106, video streaming system 110, the document system 112, and the information systems 114 may be or include any number of digital devices. A digital device is any device with at least one processor and memory. Digital devices are discussed further herein, for example, with reference to FIG. 14.

Examples of client systems 106 are mobile phones or tablets, desktop or laptop computing devices, virtual or augmented reality devices, and televisions or other display devices. The client systems 106 may include presence communication clients 108 (shown as multiple presence communication clients 108A through 108N). Users of the client systems 106 may interact with the presence communication clients 108 as described in more detail herein.

Examples of the server system 102 are one or more computer servers operated on-premises of an entity operating the server system 102 or off-premises at a facility operated by another entity. Although the environment 100 depicts a single one of the server system 102, it is to be understood that there may be multiple of the server system 102 in various configurations, such as a mixture of on-premises and off-premises at one or more facilities. The server system 102 may include a presence communication server 104. The presence communication server 104 may interact with the presence communication clients 108 as described in more detail herein.

The presence communication clients 108 may receive indications of availability (which may be referred to as availabilities) from users of the client systems 106. The presence communication clients 108 may also determine or receive locations of the client systems 106, such as through Global Positioning Service (GPS), A-GPS, or other location technologies. A first presence communication client 108 may transmit the availability and location to the presence communication server 104. The presence communication server 104 may receive the availability and location and provide the availability and location to second presence communication clients 108. A second presence communication client 108 may use the availability and location to request services from the first presence communication client 108. The first presence communication client 108 may accept the request for services, and the server system 102 may establish a presence communication between the first presence communication client 108 and the second presence communication client 108. A presence communication, which may include video transmitted from the first presence communication client 108 to the second presence communication client 108 and instructions transmitted from the second presence communication client 108 to the first presence communication client 108, is described in more detail herein.

In various embodiments, the presence communication server 104 may keep a history of users’ locations and use the location history in various ways, such as to respond to requests for services at a location. For example, a user be available at a retail store frequently. The presence communication server 104 may infer that the user works at the retail store and thus assign the retail store as an expertise of the user, so that the user may be identified in response to searches related to the retail store.

The presence communication clients 108 and the presence communication server 104 (individually or in a group) may be referred to herein as the presence communication system, a communication system, or as a system. Accordingly, the presence communication system (or the system) may be interpreted as comprising any of the presence communication clients 108 and the presence communication server 104. Similarly, functionality described as performed by the presence communication system (or the system) may be performed by any of the presence communication clients 108 and the presence communication server 104. The presence communication server 104 may be referred to herein as a communication server or as a server. Similarly, the presence communication clients may be referred to as communication clients or as clients.

Examples of video streaming system 110, the document system 112, and the information systems 114 are one or more computer servers operated on-premises of an entity operating the server system 102 or off-premises at a facility operated by another entity. The video streaming system 110 may receive video transmitted from one presence communication client 108 and transmit it to another presence communication client 108. The document system 112 may receive instructions transmitted from one presence communication client 108 and transmit it to another presence communication client 108. The information systems 114 may provide information or services to the presence communication server 104 or to the presence communication clients 108, such as mapping services, artificial intelligence or machine learning services, storage services, product or services information services, or information retrieval services.

In some embodiments, the communication network 116 may represent one or more computer networks (for example, local area networks (LANs), wide area networks (WANs), or the like). The communication network 116 may provide or facilitate communication between any of the presence communication clients 108 and the presence communication server 104. In some implementations, the communication network 116 comprises computer devices, routers, cables, or other network topologies. In some embodiments, the communication network 116 may be wired or wireless. In various embodiments, the communication network 116 may comprise the Internet, one or more networks that may be public, private, IP-based, non-IP based, and so forth.

Although the environment 100 depicted in FIG. 1 has a specific configuration and the corresponding description relates specific functionality and features, it is to be understood that variations of the configuration depicted, or the functionality and features described are possible. For example, there may be more than one server system 102. As another example, features or functionality of the video streaming system 110, the document system 112, or the information systems 114 may be provided by the presence communication server 104 or the presence communication clients 108. Accordingly, the disclosure is not limited to the description herein.

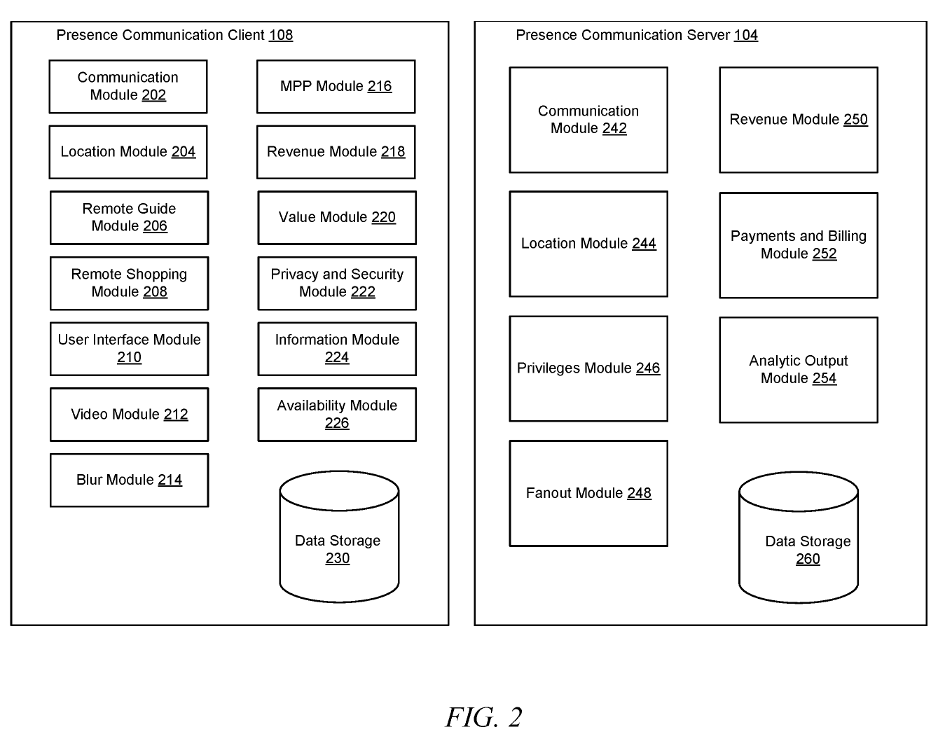

FIG. 2 is a block diagram depicting components of the presence communication client 108 and the presence communication server 104 in some embodiments. The presence communication client 108 includes a communication module 202, a location module 204, a remote guide module 206, a remote shopping module 208, a user interface module 210, a video module 212, a blur module 214, a misuse prevention and protection module 216, a revenue module 218, a value module 220, a privacy and security module 222, an information module 224, an availability module 226, and a data storage 230. The presence communication server 104 includes a communication module 242, a location module 244, a privileges module 246, a fanout module 248, a revenue module 250, a payments and billing module 252, an analytic output module 254, and a data storage 260.

The communication module 202 of the presence communication client 108 may send requests or data between the presence communication client 108 and any of the presence communication server 104, the video streaming system 110, the document system 112, or the information systems 114.

The location module 204 may receive or determine the location of the client systems 106. The remote guide module 206 may perform or enable remote guide functionality as described herein. The remote shopping module 208 may perform or enable remote shopping functionality as described herein.

The user interface module 210 may provide user interfaces for a user of the presence communication client 108. The user interface module 210 may also receive instructions from the user of the presence communication client 108, or generate new instructions based on the instructions, and output the instructions or the new instructions.

The video module 212 may capture video and transmit the video to the video streaming system 110. The video module 212 may also receive video from the video streaming system 110 and display the video for a user of the presence communication client 108.

The blur module 214 may blur a portion of video transmitted during a presence communication. The blur module 214 may also unblur video received during a presence communication. Blurring a portion of a video may be interpreted as blurring the entire video (for example, blurring the entirety of a video frame) or as less than the entire video (for example, blurring a portion of a video frame that is less than the entirety of the video frame). Blurring a portion of a video may also be interpreted as blurring a portion of a video for a period of time, or periodically, or otherwise in a fashion that obscures the portion of the video so as to render the portion of the video obscured. Instead of or in addition to transmitting the blurred portion of the video, the blur module 214 may transmit a frame of the video that has the blurred portion, or another representation of the blurred portion of the video. Additionally or alternatively, the blur module 214 may transmit an indication that the receiver is to display a blurred

The misuse prevention and protection module 216 may receive messages from other presence communication clients 108 and have the messages processed by one or more artificial intelligence or machine learning systems to generate revised messages. The misuse prevention and protection module 216 may then output the revised messages for a user of the presence communication client 108. Examples of processing are modifying an intention, tone, substance, or words of the messages and translating the messages into a language of the user.

The revenue module 218 may identify items that are in video transmitted between presence communication clients 108 or locations in the video. The revenue module 218 may then communicate with the presence communication server 104 so that a portion of any revenue for the presence communication may be attributed by the presence communication server 104 to a person or entity associated with the items or the locations. The revenue module 218 may also allow a user of the presence communication client 108 to set a billing rate for presence communications and optionally, a multiplier for when the user has set his or her availability to other than available (for example, busy or sleeping).

The value module 220 may, when a first presence communication client 108 is in a presence communication with a second presence communication client 108, determine a value of the presence communication or of the location of the presence communication and transmit the value to a third presence communication client 108. If a user of the third presence communication client 108 is willing to pay the value, another presence communication may be established between the first presence communication client 108 and the third presence communication client 108, which may be subject to approval by a user of the second presence communication client 108.

The privacy and security module 222 may identify items in video captured by a presence communication client 108 and determine that an item in the video should be blurred. For example, the item may include a part of a person or other identifiable information of the person. The privacy and security module 222 may then cause the video module 212 to blur the item in the video. The privacy and security module 222 may also generate an identifier for the item, which may be transmitted along with the video to another presence communication client 108. The privacy and security module 222 on the other presence communication client 108 determine if the identifier matches an identifier stored by the other presence communication client 108 and if so, cause the blur module 214 to unblur the item in the video.

The information module 224 may obtain information or services from the information systems 114.

The availability module 226 may allow a user of the presence communication client 108 to set an availability of the user. In some embodiments, the availability may be either available or unavailable. In some embodiments, there may be multiple availabilities, such as available, busy, sleeping, and unavailable.

The data storage 230 may include data stored, accessed, or modified by any of the modules of the presence communication client 108 and the data storage 260 may include data stored, accessed, or modified by any of the modules of the server system 102. The data storage 230 or the data storage 260 may include any number of data storage structures such as tables, databases, lists, or the like. The data storage 230 or the data storage 260 may include data that is stored in memory (for example, random access memory (RAM)), on disk or on solid-state devices, or some combination of in-memory and on-disk or on solid-state devices.

The communication module 242 of the server system 102 may send requests or data between the presence communication server 104 and any of the presence communication client 108, the video streaming system 110, the document system 112, or the information systems 114.

The location module 244 may receive locations of presence communication clients 108 and transmit the locations to other presence communication clients 108.

The privileges module 246 may grant and revoke privileges to presence communication client 108. For example, the privileges module 246 may grant the privilege to utilize voice or video in a presence communication to presence communication clients 108.

The fanout module 248 may determine when a presence communication client 108 has ended a presence communication (for example, prematurely, when the presence communication client 108 loses connectivity) and may identify another presence communication client 108. Another presence communication may be established with the other presence communication client 108.

The revenue module 250 may identify items that are in video transmitted between presence communication clients 108 or locations in the video. The revenue module 250 may then attribute a portion of the revenue to a person or entity associated with the items or the locations.

The billing module 252 may determine a start and an end of a presence communication. The billing module 252 may also determine, based on the start and the end of the presence communication, a first amount to credit a first account associated with a first user of a first presence communication client 108 and a second amount to debit a second account associated with a second user of a second presence communication client 108. The billing module 252 may then credit the first account by the first amount and debit the second account by the second amount. The billing module 252 may also allow users of presence communication client 108 to purchase minutes to utilize for presence communications.

The analytic output module 254 may generate analytic outputs based on data for presence communications or users of presence communication clients 108 that the presence communication server 104 captures and stores. An analytic output may include a report, a dashboard, a visualization, or other generated content that may express the results of the analysis. Examples of analytic outputs are dashboards on presence communications, amounts paid by users of presence communication clients 108 and earned by users of presence communication clients 108, and users of the presence communication clients 108.

A module of the presence communication client 108 or of the server system 102 may be hardware, software, firmware, or any combination. For example, each module may include functions performed by dedicated hardware (for example, an Application-Specific Integrated Circuit (ASIC), a Field Programmable Gate Array (FPGA), or the like), software, instructions maintained in random access memory (RAM) or read-only memory (ROM), or any combination. Software may be executed by one or more processors. Although a limited number of modules are depicted in FIG. 2, there may be any number of modules. Further, individual modules may perform any number of functions, including functions of multiple modules as described herein.

### Presence Communication System

The presence communication system may enable and allow for presence communications between presence communication clients 108. A user may utilize the presence communication system to provide his or her time, experience, skills, or services (which may be referred to as services) to other users. Such a user may be referred to as a provider user, a provider, or a provider. In some embodiments, a location of a user may be a service that the user may provide to other users. A user may also utilize the presence communication system to obtain services from other users. Such a user may be referred to as a consumer user, a consuming user, or a consumer. A user of the presence communication system may be both a provider and a consumer, and therefore a provider may utilize a presence communication client 108 to request that services be provided to him or her and to obtain those services. Similarly, a consumer may utilize a presence communication client 108 to respond to requests for services and to provide those services.

The presence communication server 104 may have an onboarding or signup process for users. During the onboarding or signup process, the presence communication server 104 may assign a user a unique identifier (for example, UserId, which may be stored as an int64 data type). During the onboarding or signup process, the user may provide information about the services the user may provide as a provider (for example, Java programming or yoga instruction). The presence communication server 104 may model a service as an expertise. Each expertise may have a unique identifier (for example, ExpertiseId, which may be stored as an int64 data type). The presence communication server 104 may generate an expertise unique identifier as a function of a category of the service and other variables (for example, ExpertiseId = f(category, x1, x2…xn)). The expertise may be viewed as analogous to a product. One advantage of the presence communication system is that expertises may be bought and sold like products.

The presence communication server 104 may receive a location from a presence communication client 108. The presence communication server 104 may generate multiple expertise unique identifiers based on the location. For example, the presence communication server 104 may multiple expertise unique identifiers based on the location (for example, ExpertiserId1 = f(‘geo’, lat, long, 1), ExpertiserId2 = f(‘geo’, lat, long, 2), …, ExpertiserId12 = f(‘geo’, lat, long, 12)). In some embodiments, the presence communication server 104 generates 12 expertise unique identifiers based on the location for 12 different zoom levels. However, the presence communication server 104 may generate fewer than or more than 12 expertise unique identifiers based on the location, such as 23 expertise unique identifiers based on the location for 23 different zoom levels. The presence communication server 104 may associate the user unique identifier with the expertise unique identifiers and build a cache of the associated data (for example, UserId -> {ExpertiseId1, ExpertiseId2, …, ExpertiseIdn}), which may be referred to as a user expertise cache. In the case of locations as expertises, a user may have 12 expertise unique identifiers in the user expertise cache. The presence communication server 104 may store the user expertise cache in random access memory or other fast-access memory.

As an illustrative and non-limiting example, a consumer may provide a search query such as “I need a plumber in San Francisco” in the search field 402. The presence communication server 104 may parse the search query and break into multiple queries of union or intersection of multiple expertises provided by the same provider. In this example the first component is expertise plumber, and the second component is provider of location service. The entire query becomes an intersection of a provider who is a plumber (expertise 1) and who is in San Francisco (expertise 2), right now. The first expertise (plumber) may be a service that the presence communication server 104 obtained from users during onboarding or signup, and second expertise, is location as expertise, may be received from presence communication clients 108 of providers when the providers utilize the presence communication clients 108. There may be other cases where this may be “either or” of two ExpertiseIds or there may be tree structure query for complex queries: for example, “while on vacation in Hawaii, I am looking for a photographer" (expertise 1) who is either from San Francisco (expertise 2) or New York (expertise 3) and at Waikiki Beach on Oahu (expertise 4).”

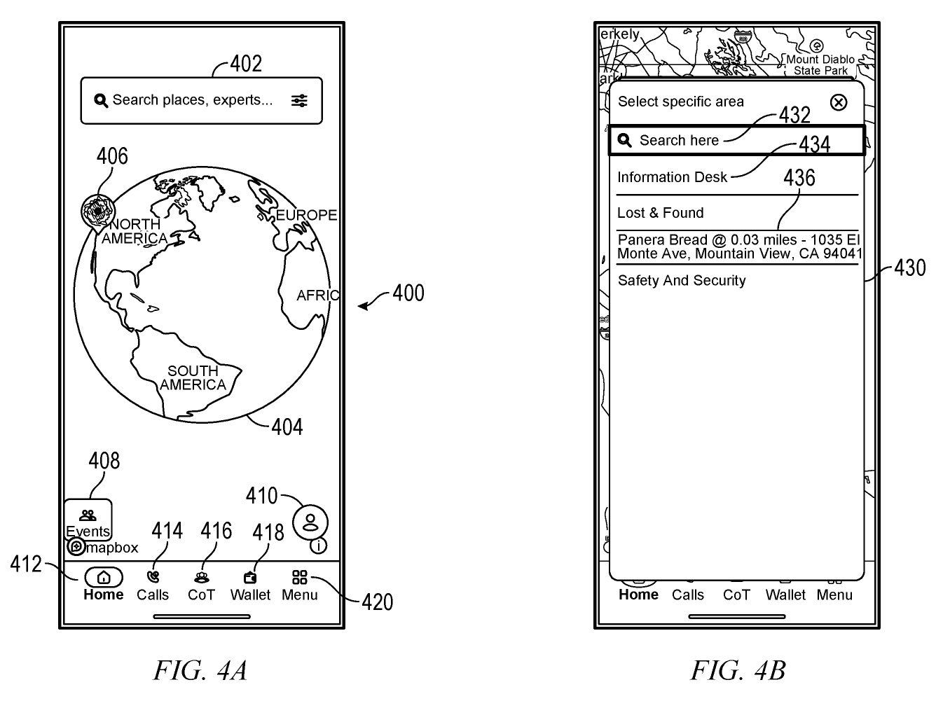

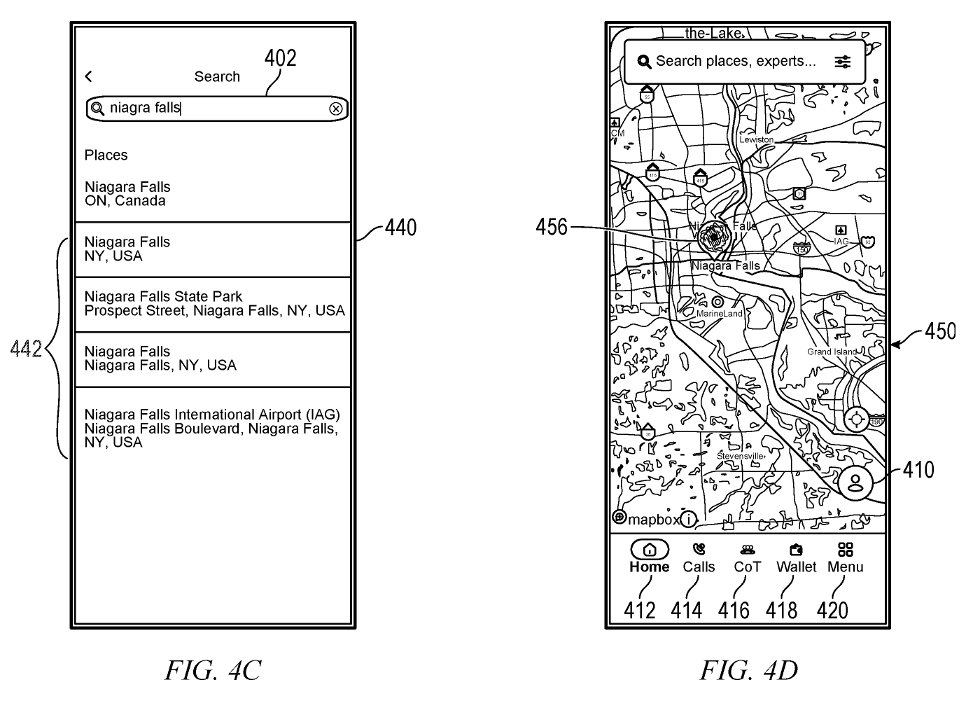

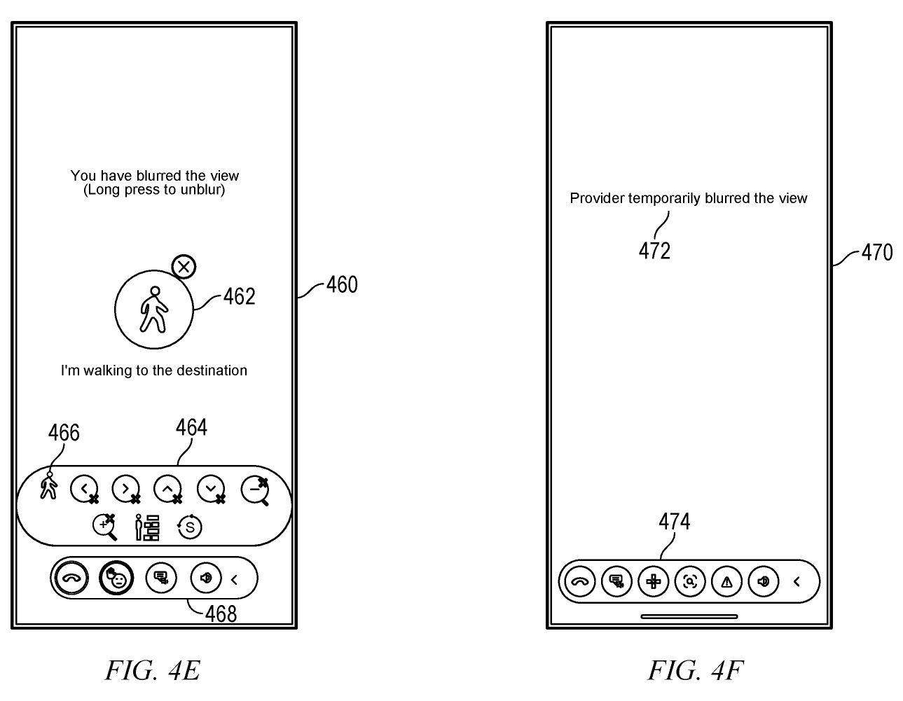

To identify providers who may provide the services, the presence communication server 104 may utilize the user expertise cache to build a requested service cache of the requested service associated with providers (for example, ExpertiseId -> {UserId List}). The presence communication server 104 may store the requested service cache in random access memory or other fast-access memory. The presence communication server 104 may identify the providers. The presence communication server 104 may transmit the identified providers to a presence communication client 108. The presence communication clients 108 may then display one or more of the identified providers, such as in one of the interfaces shown in FIGS. 4A to 4D, to the consumer.

This approach provides technical solutions to technical problems that users experience or encounter. As a non-limiting and illustrative example, there may be a long line at a rental car agency of individuals wishing to rent cars. Consequently, it may be difficult to rent a car, or it may take a lengthy period of time to do so. A user who is not at the rental car agency but who wishes to rent a car may not be able to obtain information about how long it may take to rent a car. The presence communication server 104 allows the user to search for the rental car agency, find other users who are at or near the rental car agency, and be connected with one or more of these other users. The user can thus learn from the other users the length of the line and determine whether or not to travel to the rental car agency to rent the car. The presence communication system thus benefits the consumer, by allowing the consumer to obtain information that the consumer may not otherwise have access to, as well as the provider, who is compensated for providing such information.

Using the above non-limiting example of the rental car agency line, users in line who provide their availability using the presence communication client 108 may have the same ExpertiseId. If a consumer were to search for the rental car agency, the presence communication server 104 may identify each of the users in line who is a user of the presence communication system as responsive to the search. In some embodiments, the presence communication server 104 may normalize the locations of users within a specific region to a particular latitude and longitude and use the particular latitude and longitude to calculate the ExpertiseId for each user within the specific region. The presence communication server 104 may update the ExpertiseId for a user as the location of the user changes. The user may activate and deactivate their availability using the presence communication client 108.

In some embodiments, the presence communication server 104 utilizes bounding boxes or regions to identify users in response to a search. For example, the presence communication server 104 may receive a search for a business that has a specific latitude and longitude and identify all users who have their availability activated in their applications that are within a particular radius from that specific latitude and longitude.

One advantage of the presence communication server 104 using integers for ExpertiseIds is that it allows the presence communication server 104 to use integer matching to identify users in response to location searches. Such integer matching may be an O(1) operation and thus scale well to millions or billions of users, thereby facilitating scalability and reducing potential latency. Another advantage is that the matching may not necessarily have to meet high levels of accuracy to be useful to users. For example, a user situated at a first business (for example, a hardware store) may be identified in response to a search for a second business (for example, a grocery store) that is adjacent to the first business. Even though the user may not be situated at the second business at the time of the search, the user may be able to provide services at the second business due to the proximity of the two businesses.

As another illustrative and non-limiting example, a consumer may wish to see a zebra. The presence communication server 104 may identify providers by, for example, identifying users who are at locations where zebras are known to be situated (such as at zoos) or by identifying users who indicate to the presence communication server 104 that they are proximate to zebras (for example, near zebras in the wild). The provider may use the presence communication client 108 to capture video of the zebra and provide the video to the presence communication client 108 of the consumer. The provider may be compensated for their time.

As yet another non-limiting and illustrative example, a user may wish to purchase a television or other good or service from a particular business. The user may wish to know if the particular business has televisions that the user is interested in in stock or available. The user may search for providers located at the particular business and the presence communication server 104 may connect the consumer with a provider at the particular business. The provider may show the consumer one or more televisions and be compensated for their time.

In some embodiments, the presence communication server 104 may allow the consumer to control the presence communication client 108 of the provider using a limited set of instructions. For example, the presence communication client 108 of the consumer may allow the consumer to cause the presence communication client 108 of the provider to zoom in or out on a scene or to pan the mobile phone or other device. For example, example controls that the presence communication client 108 of the consumer may be controls to cause the mobile phone or other device of the provider to zoom in or zoom out, controls to request that the provider pan to the left or to the right, controls to request that the provider move to the left or to the right, and a control to request that the provider stop moving. Other controls are possible. In some embodiments, if the provider allows the consumer to control their mobile phone or other device, the consumer may not perform any operation (for example, taking a photo or video) without express permission of the provider. In some embodiments, the provider may only grant permission to perform certain operations to consumers to which the provider is previously connected.

In some embodiments, the presence communication client 108 on the mobile phone or other device of the consumer may use an avatar to represent the provider. It may be difficult for the consumer to speak with the provider (for example, due to background noise) so the consumer may utilize the avatar to provide instructions to the consumer. The presence communication client 108 on the mobile phone or other device of the provider may provide visual, audible, or haptic instructions to the mobile phone or other device of the provider based on the instructions provided by the consumer. The provider may follow the visual, audible, or haptic instructions on the mobile phone or other device to perform the acts requested by the consumer.

Similarly, the presence communication client 108 on the mobile phone or other device of the consumer may capture hand gestures or facial expressions of the consumer and translate the hand gestures or facial expressions into instructions for the provider. For example, the presence communication client 108 on the mobile phone or other device of the provider may instruct the provider to smile or laugh based on the facial expressions of the consumer.

The presence communication system may have policies or rules to prevent or reduce unwanted behavior by users utilizing the presence communication system. Interactions between a consumer and a provider may be private (that is, not captured or monitored by the presence communication server 104). The presence communication system may provide user interfaces that allow users to report unwanted or inappropriate behavior by other users. Such reporting may assist in preventing or reducing unwanted behavior by users utilizing the presence communication system.

### Presence Sharing

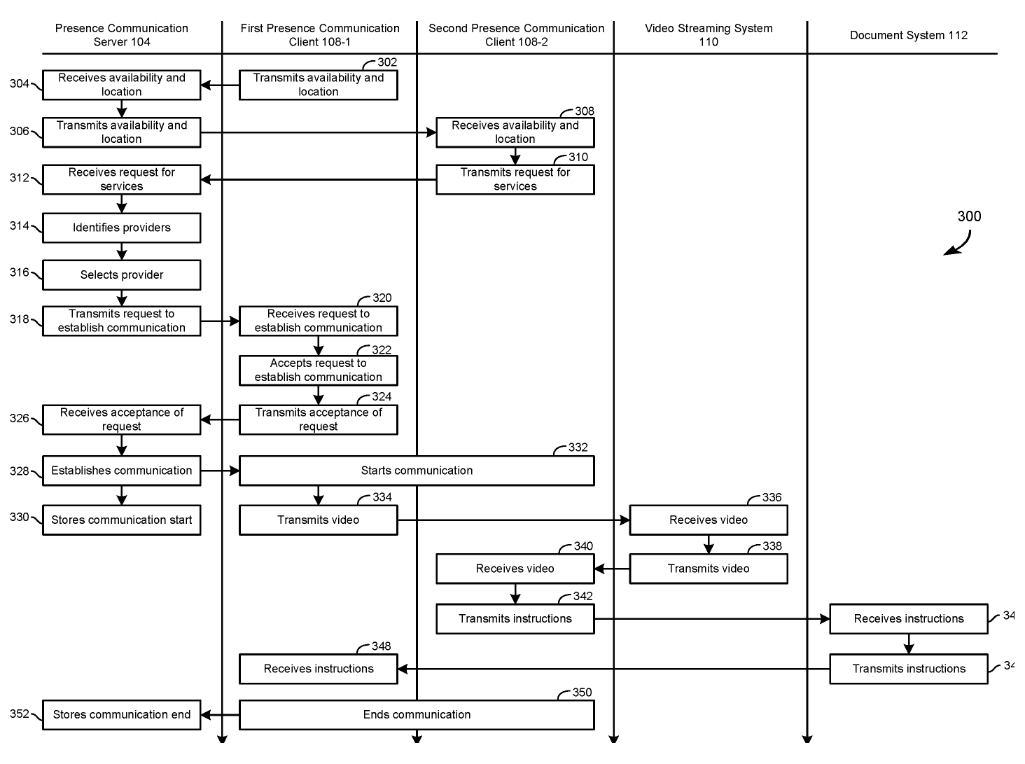

In some embodiments, the presence communication system enables a provider to share his or her presence in an environment with one or more consumers. FIG. 3 is a swimlane diagram 300 depicting interactions between different parts of the presence communication system and other systems according to some embodiments. Aspects of the swimlane diagram 300 relate to a provider sharing his or her presence with a consumer. Aspects of the swimlane diagram 300 may relate to other functionality and features of the presence communication system described herein.

In the description of the swimlane diagram 300, a user of the first presence communication client 108-1 is referred to as the provider and a user of the second presence communication client 108-2 is referred to as the consumer. The first presence communication client 108-1 and the second presence communication client 108-2 may each have established communication channels with the presence communication server 104.

The provider may wish to use the first presence communication client 108-1 to provide services at his or her location. The provider may set his or her availability using the first presence communication client 108-1, and the first presence communication client 108-1 may determine or receive a location of the first presence communication client 108-1. At step 302 the first presence communication client 108-1 may transmit the availability and the location to the presence communication server 104.

At step 304 the presence communication server 104 may receive the availability and location. At step 306 the presence communication server 104 may transmit the availability and location to other presence communication clients 108, such as the second presence communication client 108-2. At step 308 the second presence communication client 108-2 receives the availability and the location.

FIG. 4A depicts an example interface 400 that the second presence communication client 108-2 may provide in some embodiments to the consumer. The interface 400 includes a search field 402 and a map 404. The consumer may search for locations or services using the search field 402. The interface 400 may allow the consumer to zoom the map 404. The map 404 displays a user icon 406. The user icon 406 indicates that a provider, such as the provider of the first presence communication client 108-1, is available at the location of the user icon 406 on the map 404. The interface 400 also includes an events button 408, a location button 410, a home button 412, a calls button 414, a circle of trust (CoT) button 416, a wallet button 418, and a menu button 420. The consumer may utilize these buttons to access various features or functionality of the presence communication system, as described herein. For example, the provider may utilize the menu button 420 to set his or her availability or to add services that the provider may provide.

FIG. 4B depicts an example interface 430 that the second presence communication client 108-2 may provide in response to the consumer selecting the user icon 406 on the map 404. The interface 430 includes a search field 432 that the consumer may utilize to search for locations or services. The interface 430 also displays services that the consumer may utilize, such as an information desk service 434 and a service at a Panera Bread restaurant 436 that is approximately 0.03 miles from the location of the provider.

FIG. 4C depicts an example interface 440 that the second presence communication client 108-2 may provide in response to the consumer providing a search query in the search field 402. The interface 440 displays a list 442 of search results in response to the search query. FIG. 4D depicts an example interface 450 that the second presence communication client 108-2 may provide in response to the consumer selecting a search result in the list 442. The interface 450 displays a user icon 456 that is at the location corresponding to the selected search result.

Returning to FIG. 3, at step 310 the second presence communication client 108-2 may transmit a request for services (for example, services at a location, such as depicted in FIGS. 4B and 4D) to the presence communication server 104. At step 312 the presence communication server 104 may receive the request for services. At step 314 the presence communication server 104 may identify providers who may provide the services. For example, the presence communication server 104 may identify providers who are at or near the location that the services are requested at, either using a search query provided in the search field 402 or using a selection of a user icon 406 at a location.

Returning to FIG. 3, at step 314 the presence communication server 104 may identify providers. At step 316 the presence communication server 104 may select a provider from among the identified providers. At step 318 the presence communication server 104 may transmit a request to establish a presence communication to the presence communication client 108-1 of the identified provider. At step 320 the first presence communication client 108-1 receives the request to establish the presence communication. The first presence communication client 108-1 may display a user interface to the provider that there is a request for his or her services at the location requested by the consumer. The first presence communication client 108-1 may also display information about the services requested, the amount the provider may be paid for his or her services, or other information. The provider may accept or reject the request.

At step 322 the first presence communication client 108-1 accepts the request, such as in response to the provider accepting the request for his or her services. At step 324 the first presence communication client 108-1 transmits the acceptance of the request to the presence communication server 104. At step 326 the presence communication server 104 receives the acceptance of the request. At step 328, the presence communication server 104 establishes a presence communication between the first presence communication client 108-1 and the second presence communication client 108-2. At step 332 the first presence communication client 108-1 and the second presence communication client 108-2 start the presence communication. At step 330 the presence communication server 104 stores a start of the communication.

FIG. 4E depicts an example interface 460 that may be provided by the first presence communication client 108-1 and FIG. 4F depicts an example interface 470 that may be provided by the second presence communication client 108-2 in some embodiments. According to some embodiments, at the beginning of a presence communication, the first presence communication client 108-1 of the provider does not transmit video. For example, the provider may not be ready to transmit video to the consumer, or the provider may not yet be at the requested location. The consumer may be informed that the provider is not ready to transmit video. The provider may have to choose to transmit video before the first presence communication client 108-1 begins transmitting video to the second presence communication client 108-2.

Alternatively, the first presence communication client 108-1 may transmit video at the beginning of the presence communication, and the provider may choose to blur the video. For example, the interface 460 includes a button 466 that the provider may choose to blur the video and to inform the consumer that the video is blurred. The first presence communication client 108-1 may display a user interface element 462 to indicate to the provider that the provider has informed the consumer that the video is blurred. The interface 470 may accordingly provide a message 472 that indicates that the provider has temporarily blurred the view, and the video is shown as blurred in the interface 470. The video is also shown as blurred in the interface 460 so that the provider is aware that the video is blurred. The first presence communication client 108-1 may not actually transmit blurred video but may instead transmit a blurred frame of the video or some other blurred representation of the video.

In some embodiments, the first presence communication client 108-1 does not actually transmit blurred video or the blurred representation of the video. Instead, if the provider selects the button 466, the first presence communication client 108-1 transmits an indication to the second presence communication client 108-2 to display the message 472. The second presence communication client 108-2 displays the message 472 and displays a simulated blurred view.

As described in more detail herein, the interface 470 displays buttons 474 that the consumer may use to provide instructions, using a limited set of instructions to the provider or to perform other actions for the presence communication. The interface 460 displays buttons 464 that the provider may utilize to respond to the consumer or provide information to the consumer using a limited set of responses. The interface 460 also displays buttons 468 that the provider may utilize to perform other actions for the presence communication.

Returning to FIG. 3, at step 334, the first presence communication client 108-1 may transmit video to the video streaming system 110. At step 336 the video streaming system 110 may receive the video. The video streaming system 110 may process the video or perform other actions with respect to the received video. At step 338 the video streaming system 110 may transmit the video to the second presence communication client 108-2. At step 340 the second presence communication client 108-2 may receive the video.

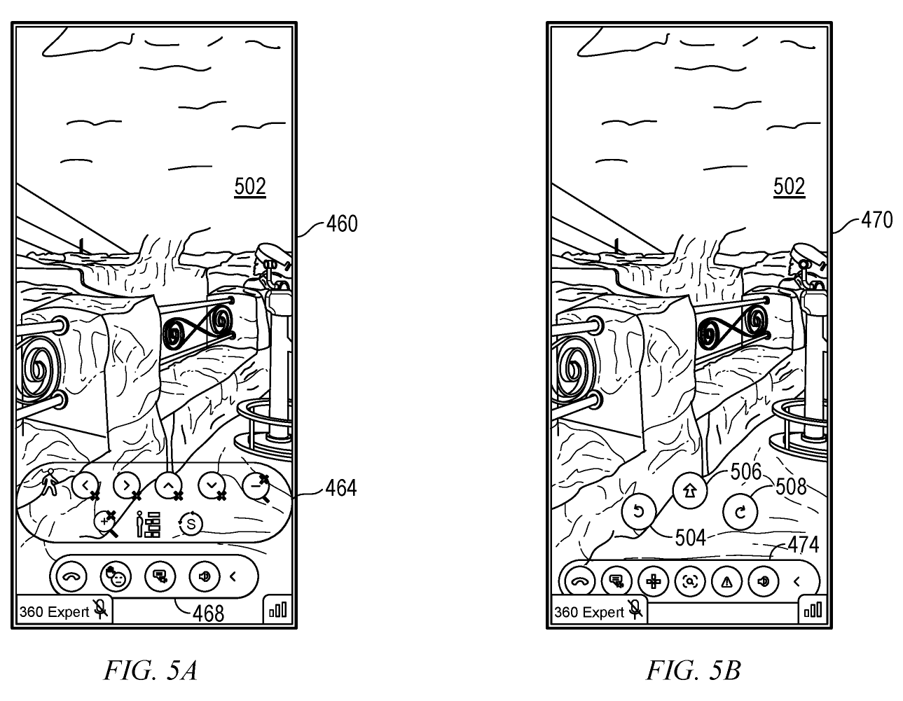

FIG. 5A depicts the interface 460 and FIG. 5B depicts the interface 470 when the first presence communication client 108-1 is capturing video and transmitting video to the second presence communication client 108-2. The provider is using the first presence communication client 108-1 to capture video of an environment 502 and the first presence communication client 108-1 is transmitting the video to the second presence communication client 108-2, which is displaying the video in the interface 470 to the consumer. The consumer can thus take advantage of the presence of the provider in the environment 502 by seeing video that the first presence communication client 108-1 is capturing and transmitting to the second presence communication client 108-2.

While the first presence communication client 108-1 is transmitting the video to the second presence communication client 108-2, the provider may control the transmission of the video. For example, the provider may long press on the screen of the client system 106 to cause the first presence communication client 108-1 to stop transmitting video and may long press again on the screen to cause the first presence communication client 108-1 to resume transmitting video. The first presence communication client 108-1 may also allow the provider to transmit video with selected portions blurred. For example, while the first presence communication client 108-1 is transmitting blurred video, the provider may select a portion of the video displayed by the interface 460 to cause the first presence communication client 108-1 to unblur the selected portion. As an illustrative and non-limiting example, the provider may be sharing his or her presence at an event featuring multiple celebrities. The provider may be capturing video of the multiple celebrities. If the consumer is only interested in seeing one celebrity, the provider may blur the video and select only the portion of the video that includes the celebrity the consumer is interested in seeing.

In some embodiments, the first presence communication client 108-1 automatically performs on-device filtering to filter out unwanted or unnecessary content and blur such unwanted or unnecessary content. For example, the consumer may be interested in seeing televisions in a store. The first presence communication client 108-1 may perform object recognition in the captured video and blur portions of the video that do not include televisions. One advantage of this approach is that it may allow providers to feel more comfortable about capturing video of their surroundings and transmitting the video to consumers who the providers may or may not know.

Returning to FIG. 3, at step 342 the second presence communication client 108-2 may transmit instructions from the limited set of instructions to the document system 112. At step 344 the document system 112 receives the instructions. At step 346 the document system 112 transmits the instructions to the first presence communication client 108-1. At step 348 the first presence communication client 108-1 receives the instructions.

Returning to FIGS. 5A and 5B, the consumer may desire that the provider move in the environment 502. The consumer may utilize the button 504, the button 506, or the button 508 to request that the provider turn to the left, move forward, or turn to the right, respectively. If the consumer selects one of these buttons, the second presence communication client 108-2 may transmit instructions corresponding to the button to the first presence communication client 108-1. The first presence communication client 108-1 may receive the instructions and output an audible instruction to the provider in the language of the provider. For example, if the consumer selects the button 506 to request that the provider move forward, the first presence communication client 108-1 may audibly output a request such as “please move forward” in the language of the provider.

In various embodiments, the consumer may long press on the interface 470 to cause the second presence communication client 108-2 to display a red dot laser on the interface 470 at the position where the consumer long pressed. The second presence communication client 108-2 may also transmit an instruction to the first presence communication client 108-1 that causes the first presence communication client 108-1 to display another red dot laser on the interface 460 at the position where the consumer long pressed. The red dot laser feature and functionality allow the consumer to direct the provider to a portion of the environment 502 that the consumer wants the provider to focus on or move the client system 106 of the provider closer to.

If the provider cannot or does not want to comply with a request from the consumer, the provider may utilize one of the buttons 464 to respond using a limited set of responses. For example, the buttons 464 allow the provider to respond that the provider cannot or does not want to move to the left, move to the right, move forward, move back, zoom in, or zoom out. The first presence communication client 108-1 may receive the input by the provider and transmit a response corresponding to the input to the second presence communication client 108-2. The second presence communication client 108-2 may receive the response and output an audible response to the consumer in the language of the consumer. For example, if the provider selects a button to indicate that the provider cannot move forward, the second presence communication client 108-2 may audibly output a response such as “the provider is unable to move forward” in the language of the consumer.

Returning to FIG. 3, at step 350, the presence communication may end. For example, either the provider or the consumer may request to end the presence communication. At step 352 the presence communication server 104 stores the end of the presence communication. Although not depicted in FIG. 3, the first presence communication client 108-1 and the second presence communication client 108-2 may send heartbeats to the presence communication server 104. As described in more detail herein, the presence communication server 104 may utilize the start and the end of the presence communication, and optionally the heartbeat information, to determine how much to debit an account of the consumer and how much to credit an account of the provider.

In various embodiments, the first presence communication client 108-1 transmits to the presence communication server 104 times when the first presence communication client 108-1 is transmitting blurred video or is not transmitting video. The first presence communication client 108-1 does this so that the consumer is not charged for the times when the video is blurred or is not transmitted. Similarly, the first presence communication client 108-1 may transmit to the presence communication server 104 information about when the first presence communication client 108-1 is transmitting video that has a portion partially blurred so that the consumer is only paying for the portion of the video that is not blurred.

A provider may have multiple skills that the provider may provide at times. The provider may not be available at certain times to provide skills via video calls but may be available to provide skills via telephone calls. The provider may specify that the provider may provide skills via video calls, telephone calls, or both on a skill by skill basis. The provider may then specify that the provider is available for only telephone calls or both telephone calls and video calls based on the provider’s availability. For example, the provider may turn on a Do Not Disturb (DnD) mode for video calls only, indicating that the provider is available for only telephone calls. In some embodiments, the presence communication client 108 executing on the mobile phone or other device of the provider may automatically set the provider’s availability. For example, the application may detect that the provider is driving and therefore set the provider’s availability to only telephone calls. Other variants are possible for multi-skilled users. A provider may specify that, during certain hours of the day, the user is able to offer services based on skills that require only a short duration of time to render. For example, the provider may be available to provide short duration services, such as verifying whether a particular store is open or not, during normal business hours, but able to provide longer duration services, such as proof reading, in the evenings or on weekends.

### Remote Guide

Individuals often find themselves in new or unfamiliar environments and must navigate those environments in order to accomplish their objectives. They may resort to utilizing applications on mobile devices to assist them, but existing applications often do not provide sufficient assistance. For example, an individual in an unfamiliar building, such as a conference center, may need to reach a specific area of the building, such as a conference room. However, the interior of the conference center may not be mapped and thus the individual may not be able to use an application to go to the conference room. As another example, an individual may utilize a mapping application to navigate to a building, such as an embassy. The mapping application may provide instructions that allow the individual to arrive at the embassy but not locate the embassy entrance. The individual may then have to spend time searching for the embassy entrance. In both examples, existing technology is insufficient to allow the individuals to achieve their objectives in a timely manner.

The presence communication system may provide remote guide functionality that allows a provider to guide a consumer. The presence communication server 104 may receive requests from consumers to have remote guide services provided to them, identify providers who may provide remote guide services, and connect the consumers users with the providers providing remote guide services. The presence communication system may thus allow the consumers to obtain remote guide services that help them reach their objectives, and, importantly, save them significant amounts of time. The presence communication system may allow the providers, no matter where they may be located, to provide the remote guide services and to be compensated for their services. Similarly, the presence communication system may allow consumers to provide predicate guidance to a provider to better enable the provider to fulfill a request.

The presence communication system may allow providers to provide guide services to consumers in real time. The presence communication server 104 may receive a request from a consumer to have guide services provided to him or her at a specific location. For example, the consumer may request that he or she be guided to a conference room in a conference center. The presence communication server 104 may identify users of the presence communication server 104 who may provide guide services for that specific location as providers of the guide services. For example, the presence communication server 104 may identify users who are at the conference center as providers. As another example, the presence communication server 104 may identify users whose location history profiles indicate that they have previously been at that specific location as providers. As another example, the presence communication server 104 may identify users whose profiles indicate that they have knowledge of or familiarity with that specific location (for example, having been trained on the specific location) as providers. Once the presence communication server 104 has identified a user as a provider, the presence communication server 104 may transmit the consumer’s objective to the provider.

In various embodiments, a user of the presence communication server 104 may be able to indicate his or her familiarity with or knowledge of locations during an onboarding or signup process of the presence communication server 104. The presence communication server 104 may store such information in the user’s profile and the presence communication server 104 may utilize the profile information in identifying users as providers. In some embodiments, the presence communication server 104 may require the user to specify the dates when the user had last accessed locations. In identifying users who may provide guide services for a location, the presence communication server 104 may weigh users who accessed the location recently more than other users. Other approaches to identifying users as providers of guide services will be apparent.

After identifying the provider, the presence communication server 104 may connect the provider with the consumer. The presence communication server 104 may connect the presence communication client 108 of the consumer with the presence communication client 108 the provider, so that the presence communication client 108 of the consumer may transmit video or images or haptic feedback to the presence communication client 108 of the provider. The provider may see the video or images, or feel the haptic feedback, and utilize the presence communication client 108 to provide instructions, directions, or commands (which may be referred to as instructions). The presence communication client 108 of the provider may transmit the instructions to the presence communication client 108 of the consumer.

The presence communication client 108 of either the provider or the consumer may provide interactive user interface elements, such as buttons, direction icons, zoom in or zoom out icons, and the like, that allow the provider to provide instructions to the consumer. The presence communication client 108 may overlay the user interface elements on the video or images or display the user interface elements adjacent to the video or images. Additionally or alternatively, the application may allow providers to utilize mobile device gestures, such as tap, drag, flick, pinch, spread, press gestures and the like, to provide instructions. The presence communication client 108 of the consumer may translate such mobile device gestures into suitable instructions for the consumer. The instructions may take the form of voice instructions, direction or action icons, haptic feedback or other visual or sensory feedback that may better be understood as guidance by a consumer. Additionally or alternatively, the presence communication client 108 of the provider may receive voice instructions from the provider for direct transmission or translation to the variety of instruction forms mentioned above.

The presence communication client 108 of the consumer may provide the instructions using a combination of different modalities, such as user interface elements (for example, arrows on screens), audible instructions that are in the consumer’s language, or computer-generated voice instructions that are in the consumer’s language and are from a set of standardized voice instructions. For example, a provider may utilize certain gestures on his or her provider applications to provide instructions to the consumer, such as in which direction to walk. The consumer, similarly, may utilize certain gestures to provide instructions to the provider, such as to provide feedback on provider instructions. As another example, a user may utilize pinch or spread gestures on such user’s application to provide instructions. The pinch or spread gestures may cause the receiving user’s application to capture either zoomed-out or zoomed-in video or images and provide the zoomed-out or zoomed-in video or images to the instructing user’s application. Allowing the instructing user to control the zoom level of the consumer’s video or images may facilitate the instructing user providing instructions to the receiving user.

As another example, the instructing user may press on an icon displayed by the instructing user’s application, such as a laser icon, to provide instructions. The instructing user may press on such an icon to instruct the receiving user that the receiving user has arrived at the receiving user’s objective. For example, for the receiving user searching for a conference room in a conference center, the instructing user may press on the laser icon to indicate to the receiving user that the receiving user has arrived at the conference room. The receiving user’s application may provide a visual or audible indication that the receiving user has arrived at his or her destination.

As another example, instructing user instructions may be converted into computer-generated voice instructions by the presence communication client 108 in various embodiments. The instructing user may provide instructions via user interface elements, gestures, voice, or using a combination of these and other modalities, such as haptics. The presence communication client 108 may receive the instructions and convert the instructions into one or more of a set of standardized voice instructions that the receiving user’s application audibly provides. For example, the standardized voice instructions may be “turn left,” “turn right," “continue straight ahead until you reach the hallway” or the like.

The presence communication client 108 may provide the computer-generated voice instructions in the language of the receiving user. Additionally or alternatively, the presence communication client 108 executing on the receiving user’s mobile device may convert the instructions into the computer-generated voice instructions. One advantage of this approach is that the receiving user is provided with instructions in his or her native language. Another advantage is that the instructing user is not required to speak the same language as the receiving user to be able to provide guide services to the receiving user. This allows any provider anywhere in the world to provide real-time guide services to any consumer anywhere in the world, as long as the provider is capable of providing the services. One advantage of providing audible instructions is that it allows the receiving user to not have to look at his or her mobile device while following the instructions.

Although instructions in certain of the example user interfaces depicted in the drawings may be in English, it is to be understood that instructions may not necessarily be in English. Additionally or alternatively, the presence communication client 108 may provide instructions in another language, such as the native or preferred language of the consumer. Alternatively, the presence communication client 108 may not provide written instructions in text but instead rely on the use of arrows or other graphical indicators to instruct the consumer. One advantage of using arrows or other graphical indicators is that such user interface elements may be understood by a large percentage of users of the presence communication system. Interfaces described as being provided by the presence communication client 108 of the consumer may be provided by the presence communication client 108 of the provider, and interfaces described as being provided by the presence communication client 108 of the provider may be provided by the presence communication client 108 of the consumer.

In various embodiments, the presence communication system may also allow users to request other services, such as those related to performing tasks. For example, a consumer may have a task of replacing spark plugs of a vehicle. The consumer may view manuals or videos that explain how to perform the task but still not be able to complete it. The consumer may request that a user of the presence communication server 104 provide task assistance services. The presence communication server 104 may identify providers who can help the consumer replace the spark plugs and connect the provider with the consumer. This allows the consumer to save time and have expert assistance at the time the consumer needs it. The provider is also compensated for providing the task assistance.

The presence communication client 108 of the provider may provide user interface elements that are customized to the task. Additionally or alternatively, the presence communication client 108 of the consumer may receive voice instructions from the provider and either convert them into computer-generated voice instructions that the presence communication client 108 of the consumer audibly outputs or translate the voice instructions into the consumer’s language.

### Remote Shopping

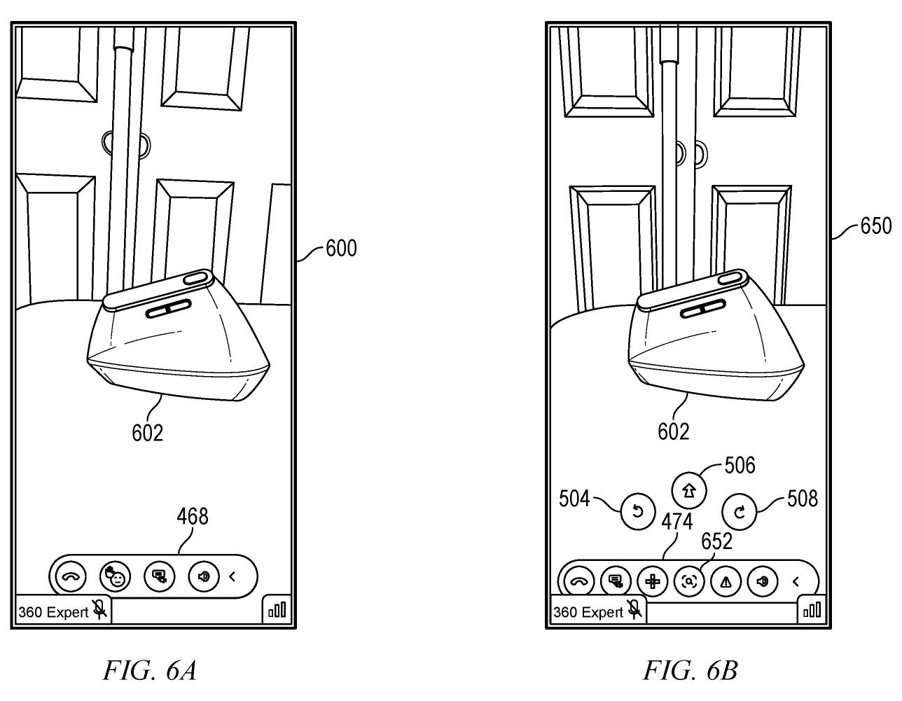

The presence communication system may provide remote shopping functionality that allows a consumer to obtain information about products or services through the provider. FIGS. 6A depicts an interface 600 that may be provided by the presence communication client 108 of the provider and FIG. 6B depicts an interface 650 that may be provided by the presence communication client 108 of the consumer in some embodiments. The interface 600 displays an item 602 that is included in the video that the presence communication client 108 of the provider is transmitting to the presence communication client 108 of the consumer. The interface 600 also displays the buttons 468. The interface 650 also displays the item 602. The interface 650 also displays the buttons 474 and the button 504, the button 506, and the button 508. The consumer may select a button 652 to cause the presence communication client 108 of the consumer to scan for a product and start remote shopping during the presence communication. The presence communication client 108 of the consumer may display an interface (not depicted in FIGS. 6A or 6B) that allows the consumer to select the item 602, such as by drawing a bounding box around the item 602 and by selecting a button once the bounding box is drawn. The presence communication client 108 of the consumer may then perform or have performed image recognition algorithms to recognize the item 602. The presence communication client 108 of the consumer may then perform or have performed a search for the item 602. If the presence communication client 108 of the consumer obtains results for the search for the item 602, the presence communication client 108 of the consumer may transmit the results to the presence communication client 108 of the provider.

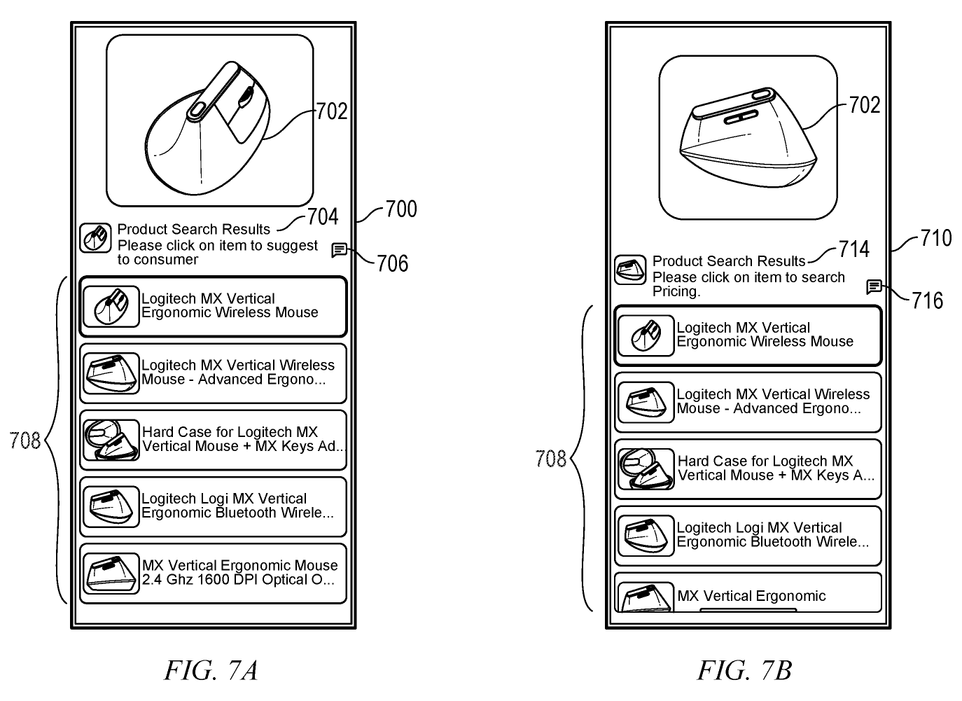

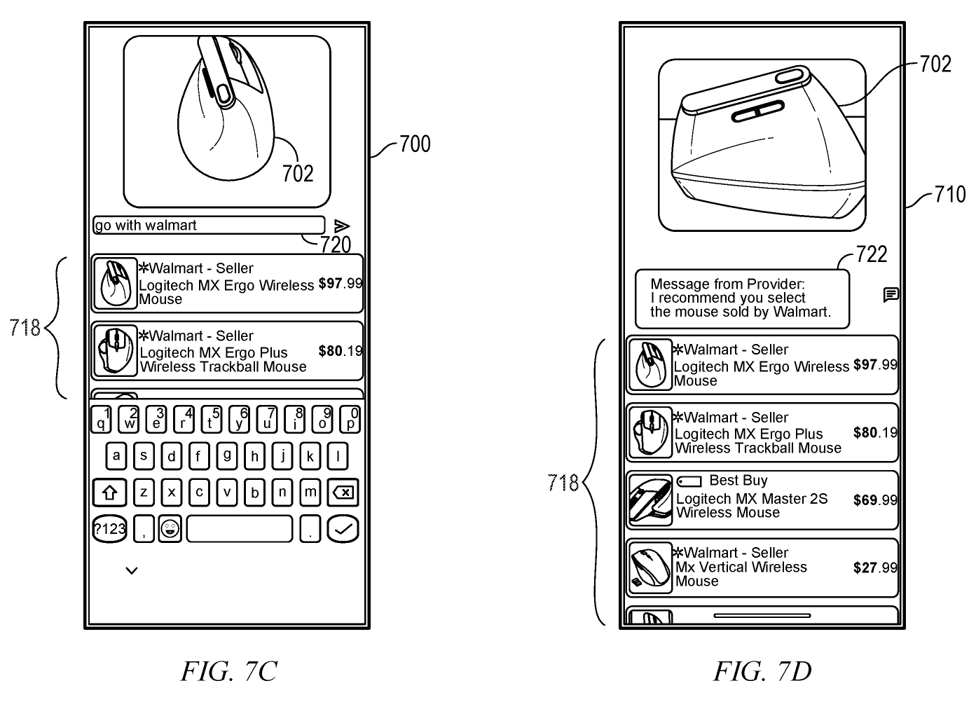

FIGS. 7A-7D depict other example interfaces that may be provided by presence communication clients according to some embodiments. FIG. 7A depicts an interface 700 that the presence communication client 108 of the provider may display after receiving the results. The interface 700 displays the item 702, instructions 704, a list 708 of the results, and a messaging button 706. The provider may use the messaging button 706 to transmit a message to the consumer. The instructions 704 indicates that the provider is to select a result to suggest to the consumer. FIG. 7B depicts an interface 710 that the presence communication client 108 of the consumer may display after receiving the results. The interface 710 displays the item 702, instructions 714, the list 708 of the results, and a messaging button 716. The consumer may use the messaging button 716 to transmit a message to the provider. The instructions 714 indicates that the consumer is to select a result to search for pricing of the item 702. The consumer may select a result to search for pricing of the item 702.

FIG. 7C depicts the interface 700 and FIG. 7D depicts the interface 710 after the consumer has selected a result to search for pricing of the item 702. The interface 710 displays a list 718 of results with pricing of the item 702, and the interface 710 displays the list 718 as well. The interface 710 displays a message field 720 into which the provider has typed the message “go with walmart.” The presence communication client 108 of the provider transmits the message to the presence communication client 108 of the consumer. The presence communication client 108 of the consumer may have the message processed by one or more artificial intelligence or machine learning systems to generate the revised message that is shown in a message 722 of the interface 710. The revised message may reflect an improved intention, tone, substance, or words relative to the message originally input by the provider.

### Online to Offline

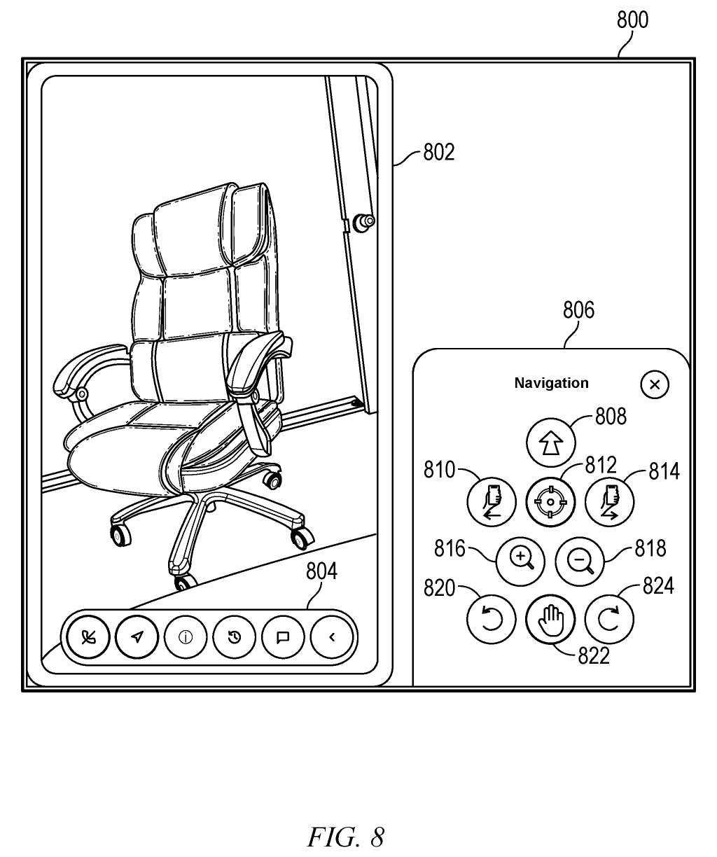

FIG. 8 depicts another example interface 800 that may be provided by a presence communication client 108 of a consumer in some embodiments. For example, a consumer may not have access to a mobile phone or tablet that may execute an application that implements the presence communication client 108 of the consumer. Instead, the consumer may utilize a browser of a desktop or laptop computing device to access a website of the presence communication server 104. The website may provide executable instructions to the desktop or laptop computing device that when executed by one or more processors of the desktop or laptop computing device cause the browser to provide the interface 800.

The interface 800 includes a region 802 in which the browser displays video transmitted by the presence communication client 108 of the provider, as well as buttons 804. The interface 800 also includes region 806 with navigation buttons. The navigation buttons include a button 808 to request that the provider move forward, a button 810 to request that the provider move to the left, and a button 814 to request that the provider move to the right. The navigation buttons also include a button 816 to request that the provider zoom in, a button 818 to request that the provider zoom out, a button 820 to request that the provider turn to the left, a button 824 to request that the provider turn to the right, and a button 822 to request that the provider stop. The navigation buttons also include a button 812 to cause the presence communication client 108 of the consumer to display a red dot laser on the region 802 at a position specified by the consumer, such as by moving an input device like a mouse. The red dot laser may be generally similar to that discussed with reference to FIGS. 5A and 5B.

### Billing and Payments

In some embodiments, the presence communication system may facilitate converting utility (as specified by, for example, money) into time by allowing consumers on the presence communication system to purchase time (for example, in increments such as minutes) using money. For example, a consumer may use the wallet button 418 (see for example FIG. 4A) to purchase minutes, such as packs of minutes in defined increments (for example, 10 minutes, 30 minutes, 60 minutes, or 120 minutes). As another example, consumers may purchase cards that provide time that can be used to obtain services on the presence communication system. The presence communication system or affiliates of the presence communication system, distributors, or resellers may provide the cards for sale. The consumer may use the purchased time to obtain services from providers on the presence communication system. The presence communication system may also facilitate converting time into utility (as specified by, for example, money) by allowing providers on the presence communication system to receive money in exchange for time spent providing services.

The presence communication system may utilize a post-paid billing model. The presence communication server 104 may charge an account of the consumer for increments of the presence communication (for example, 15 second increments). Consumers may be assured that the provider creates value and only then gets paid by the presence communication server 104. If the presence communication gets disconnected before the first increment is reached, the consumer may not be charged. One advantage of this approach is that providers are incentivized to hit the next billing increment (for example, the next 15 seconds), which may encourage providers to provide good customer service to consumers. The presence communication server 104 may have fraud detection capabilities to detect potential fraud by a consumer. For example, if a consumer is frequently disconnecting close to the first billing increment (before the first 15 seconds are completed), the presence communication server 104 may disable the ability of the consumer to participate in presence communications by removing this privilege from the consumer.

In some embodiments, for a particular amount of money, the presence communication server 104 may vary the number of minutes to which the particular amount of money equates. For example, a particular amount of money such as $100 purchased by a consumer in the United States may be equivalent to 600 minutes of services that are provided by providers that are within a first certain distance of the consumer or within the same geographic region as the consumer, such as the same city, state or province of the consumer. The $100 may be equivalent to 300 minutes of services that are provided by providers that are outside of the first certain distance but within a second certain distance of the consumer or within the same country as the consumer, such as within the other states in the United States. The $100 may be equivalent to 200 minutes of services that are provided by providers that are not within the second certain distance of the consumer, such as providers located in any country other than the United States. The presence communication system may determine locations of consumers and providers based on the locations of the devices that the consumers and the providers utilize to consume and provide services, respectively.

If a consumer requests and receives a service on the presence communication system, the presence communication system may charge the consumer the amount of time that elapsed during the consumer receiving the service, or a multiple of the amount of time. As an illustrative and non-limiting example, the consumer may have requested to see a zebra. A provider in proximity to a zebra may capture video of the zebra and provide the video to the consumer. Assume that the consumer is located within the United States, that the experience lasted five minutes, and that the provider charges a per minute rate of one dollar to provide this experience. If the provider is within the first certain distance of the consumer or within the same geographic region as the consumer (for example, the same United States state), the presence communication server 104 may debit an account of the consumer for five minutes. If the provider is outside the first certain distance but within the second certain distance of the consumer or within the same country as the consumer (for example, in another state in the United States), the presence communication server 104 may debit the account of the consumer for ten minutes. If the provider is located in a different country than the consumer (for example, outside of the United States), the presence communication server 104 may debit the account of the consumer for fifteen minutes. The presence communication server 104 may credit the account of the provider providing the services within the same geographic five dollars upon the completion of the experience (less any fees or service charges of the presence communication server 104).

In some embodiments, a consumer has an account with the presence communication server 104 and has linked the consumer account with an account of the consumer at an external financial institution, such as a bank. The consumer may purchase a number of minutes from the presence communication server 104 for a particular amount (for example, 500 minutes for $100). The presence communication server 104 may utilize a payment service (for example, a payment microservice) to withdraw the particular amount from the account of the consumer at the external financial institution. If the debit is successful, the presence communication server 104 may credit the consumer account the number of minutes and a financial account of the presence communication server 104 may be credited with the particular amount. If the consumer requests and receives a service from a provider on the presence communication server 104, the presence communication server 104 may debit the consumer account the number of minutes that the consumer utilized receiving the service (or a multiple of the number of minutes).

In some embodiments, when a provider provides a service on the presence communication server 104, the presence communication server 104 may credit an account of the provider with the presence communication server 104 the amount of money the provider charges for providing the service. If the provider wishes to withdraw money from the provider account (for example $50), the presence communication server 104 may utilize the payment service to debit the provider account and send the money to an account of the provider at an external financial institution, such as a bank.

A user may be both a provider and a consumer on the presence communication server 104. Such a user may earn money in his or her account at the presence communication server 104 by providing services and use the earned money to purchase minutes. In addition to allowing providers to transfer money in their provider accounts to their accounts at external financial institutions, the presence communication server 104 may allow consumers to convert unused time into money and transfer the money to their accounts at external financial institutions.

The presence communication server 104 may maintain time accounts for consumers on the presence communication server 104 and track the amounts of time the consumers spend in obtaining services on the presence communication server 104 and debit the time accounts of consumers accordingly. For providers, the presence communication server 104 may maintain monetary accounts for providers on the presence communication server 104 and credit providers based on their time spent providing services on the presence communication server 104. Users of the presence communication server 104 who are both consumers and providers may have both time accounts and monetary accounts.

The presence communication server 104 may set and enforce minimum or maximum per minute rates of providers. For example, the presence communication server 104 may set a maximum per minute rate for a provider service so as to avoid overcompensating the provider for the service provided. As another example, the presence communication server 104 may set a minimum per minute rate for a provider service so as to ensure that a provider is adequately compensated for providing the service.

The presence communication server 104 may vary the amount of time that may be purchased by an amount of money or the cost of an amount of time based on the geographic region in which the purchase is made. For example, the presence communication server 104 may charge $100 for 600 minutes of time in the United States and 1000 Mexican pesos for 600 minutes of time in Mexico. The presence communication server 104 may vary the cost of an amount of time based on geographic regions such as countries so as to take into account differences in purchasing power between geographic regions. The presence communication server 104 may allow consumers to purchase time only according to the rate of the geographic regions in which the consumers are located. The presence communication server 104 may do so for various reasons, such as to avoid consumers arbitraging price differences between geographic regions by, for example, purchasing time in a low-cost geographic region and using the time to obtain services in a high-cost geographic region.

In some embodiments, the presence communication server 104 may vary the cost in time to obtain a service in a geographic region based on the geographic region from which the service is requested. For example, the presence communication server 104 may charge a consumer in India 20 minutes for a service that lasted 10 minutes but charge a consumer in Germany 10 minutes for an equivalent service that lasted an equivalent amount of time. The presence communication server 104 may do so, for example, to accommodate consumer expectations as to the cost of services in geographic regions. It will be understood that the presence communication server 104 may vary the amount consumers are charged for a service in various ways (for example, based on time of day, day of week, time of year, etc., geographic regions of consumers or providers, or to incentivize provision or consumption of particular services).

In various embodiments, instead of or in addition to the presence communication server 104 utilizing time to facilitate the provision and consumption of services on the presence communication server 104, the presence communication server 104 may utilize points, credits, or virtual currency. For example, the presence communication server 104 may allow consumers to purchase virtual currency and use the virtual currency to obtain services on the presence communication server 104. The presence communication server 104 may convert the virtual currency to actual currency of the jurisdictions in which the providers on the presence communication server 104 reside and allow the providers to transfer actual currency to their external financial institutions such as banks.

One advantage of the technology described herein is that it reduces barriers to consumers purchasing time that can be used to obtain services on the presence communication server 104 and utilizing the time to obtain services. Another advantage is that the technology obviates the need to send money across borders from consumers to providers to pay for services on the presence communication server 104 that the consumers obtain from the providers. Yet another advantage is that it allows providers to obtain value for their time from various sources, thereby allowing providers not to be tied to their employers. Another advantage is that consumers may come to perceive the presence communication system due to the various services that consumers may obtain via the presence communication server 104, as indispensable, or nearly so, akin to a utility. Providers may have similar perceptions. Other advantages of the technology described herein will be apparent.

### Privileges

In various embodiments, users (either providers or consumers) may be required by the presence communication server 104 to earn privileges to use certain features. For example, users may only be allowed to use a certain number of minutes each day (for example, 30 minutes). The presence communication server 104 may enforce this limitation to reduce or eliminate potential misuse. The presence communication server 104 may disable high risk privileges like voice, video by default. Once the presence communication server 104 determines that a user is eligible for a privilege, the presence communication server 104 may enable the privilege for the user. The presence communication server 104 may take away privileges from a user if certain criteria are no longer met. For example, a user may be enabled for a voice privilege, but if a rating associated with the user falls below a certain threshold, the presence communication server 104 may disable the voice privilege for the user.

### Misuse Prevention and Protection

A presence communication client 108 may receive messages from other presence communication clients 108. The presence communication client 108 (for example, the misuse prevention and protection module 216) may have the messages processed by one or more artificial intelligence or machine learning systems to generate revised messages. The presence communication client 108 may then output the revised messages for a user of the presence communication client 108. Examples of processing are modifying an intention, tone, substance, or words of the messages and translating the messages into a language of the user. For example, a message such as “go to the building” may be revised to be “Please proceed to the building in front of you.” The presence communication client 108 may also convert the message to speech using one or more artificial intelligence or machine learning systems that provide text to speech functionality. One advantage of this approach is that it reduces or eliminates the likelihood that a user will have negative experiences using the presence communication system. Combined with gesture controls and other privileges, the prevention of and protection against misuse may allow anyone to monetize their presence without worry of negative experiences.

### Provider Billing

In some embodiments, a provider has multiple modes, such as an available mode (not engaged in a presence communication), a busy mode (engaged in a presence communication), and a sleep mode (not engaged in a presence communication). The provider may set a normal billing rate and may switch to a busy mode or a sleep mode using the presence communication client 108. When switching to the busy mode, the presence communication client 108 may automatically increase the normal billing rate by a first amount, which may be a multiple of the normal billing rate. The presence communication client 108 may also automatically increase the normal billing rate by a second amount, which also may be a multiple of the normal billing rate. In some embodiments, the increased normal billing rate may be higher for the sleep mode than for the busy mode. This approach may enable or encourage a user to remain as a provider in the presence communication system, as the provider may never know when his or her five minutes of time could earn the provider a significant amount of money.

### Fanout Model

The presence communication server 104 (for example, the fanout module 248) may determine when a presence communication client 108 of a provider has ended a presence communication with a presence communication client 108 of a consumer. For example, the presence communication client 108 of the provider may lose connectivity, which may cause the presence communication to terminate prematurely. The presence communication server 104 may then identify another provider to start another presence communication for the consumer that may achieve the objectives of the consumer. The presence communication server 104 may then establish another presence communication between the presence communication client 108 of the other provider and the presence communication client 108 of the consumer.

For example, a consumer in the United States may wish to see the Eiffel Tower in Paris. The presence communication server 104 may find a provider at or near the Eiffel Tower to transmit video of the Eiffel Tower for the consumer. However, during the presence communication, the presence communication client 108 of the provider may prematurely end the presence communication. The presence communication server 104 may inform the consumer and offer the consumer the option to start another presence communication with another provider. If the consumer accepts, the presence communication server 104 may identify another provider at or near the Eiffel Tower and establish another presence communication between the presence communication client 108 of the other provider and the presence communication client 108 of the consumer.

To achieve this, the presence communication server 104 may implement a fanout model to quickly identify other providers and connect the consumer with another provider. In some embodiments, the presence communication server 104 may select a provider from among the providers originally identified by the presence communication server 104 for the original presence communication session. In various embodiments, the presence communication server 104 rebuilds the requested service cache periodically, such as every five seconds. Doing so may facilitate the presence communication server 104 finding another provider rapidly when a presence communication has ended but the consumer still has a need for a presence communication.

### Revenue Attribution

In some embodiments, a physical asset can earn revenue for an owner of the physical asset when the owner participates in the presence communication system. For example, a store owner may register the store with the presence communication server 104. If a provider earns revenue at the store, the presence communication server 104 may share a portion of the revenue with the store owner. The presence communication client 108 (for example, the revenue module 218) may identify items that are in video transmitted between presence communication clients 108 or locations in the video. The presence communication client 108 may then communicate with the presence communication server 104 so that a portion of any revenue for the presence communication may be attributed by the presence communication server 104 to a person or entity associated with the items or the locations.

A similar approach may be used for persons who have valuable names, images, or likenesses (NILs), such as celebrities. A celebrity with a valuable NIL (for example, an actor or actress or a professional athlete) may register their NIL with the presence communication server 104. If a provider earns revenue showing the person in videos the provider transmits, the presence communication server 104 may share a portion of the revenue with the person.

### Consumer Buyout

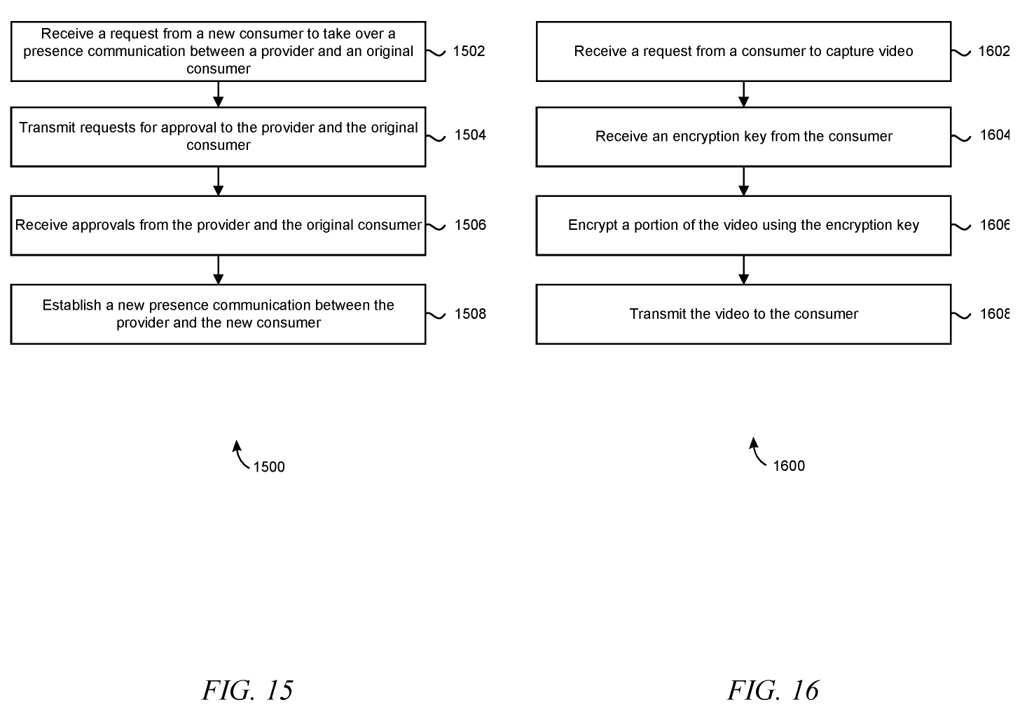

When a consumer and a provider are in a presence communication, the provider may remain in the busy mode and visible to others in the presence communication system. The billing rate of the provider in the busy mode may be a multiple of his or her normal billing rate. If a new consumer is ready to pay the higher billing rate of the provider because the presence communication has value to the consumer at the higher billing rate, the presence communication server 104 may use the following approach, as illustrated in FIG. 15, which is a flow diagram depicting a method 1500 for establishing a presence communication. At step 1502 the presence communication server 104 may receive a request from a new consumer to take over a presence communication between a provider and an original consumer. The presence communication server 104 may provide the new consumer with the higher billing rate, which may be higher than what the original consumer is paying. The new consumer may accept the higher billing rate. At step 1504 the presence communication server 104 may transmit requests to the provider and the original consumer that the provider and the original consumer approve the presence communication being transferred to the new consumer. As part of the request, the presence communication server 104 may offer the original consumer a payment to approve the request. The presence communication server 104 may also offer the provider a payment to approve the request. In some cases, the payments offered to the original consumer and the provider may be based on the higher billing rate of the provider. If both the original consumer and the provider approve, at step 1506 the presence communication server 104 may receive the approvals. At step 1508 the presence communication server 104 may then establish a new presence communication between the provider and the new consumer. In some embodiments, the presence communication server 104 may end the presence communication and establish the new presence communication. In some embodiments, the presence communication server 104 may remove the original consumer from the presence communication and add the new consumer to the presence communication, such as by transferring the video stream from the presence communication client 108 of the provider to the presence communication client 108 of the consumer.

In some embodiments, the presence communication server 104 does not inform the provider that the consumer has changed. However, the presence communication server 104 may inform the provider that the provider is earning at the higher billing rate for the presence communication. The result may be that the provider earns more for providing the same information.

An example is that a provider is in front of a disaster-stricken place and providing video to a consumer. A new consumer who is a resident may want to see if his or her relatives’ house is safe. The new consumer may take over the provider by paying a higher billing rate. Then, a media company may wish to obtain the video so that the media company may broadcast the video to its audience. The media company may take over the provider by paying an even higher billing rate. The concept may be that information may have different value depending on the consumer of the information, and the presence communication server 104 should facilitate the provider earning the highest amount of value for transmitting the information. To maintain a positive experience for consumers, each displaced consumer may receive a price approved either by the new consumer or by the presence communication server 104. This consumer buyout may occur one or more times for a presence communication, as a first new consumer may be bought out by a second new consumer, and so forth.

### Notify Me

The presence communication system may model fixed locations as expertises and give the fixed locations unique identifiers (for example, ExpertiseIds). For example, a fixed location as a store may be modeled as an expertise and given a unique identifier. A consumer may have an interest in knowing when a provider goes to the store because the consumer may want the provider to see if a product is in stock at the store. The consumer may register an interest in being notified with the presence communication server 104. Then, when a provider arrives at the store, the presence communication server 104 may determine that the provider is at the store, and notify the consumer. The presence communication server 104 may do so by comparing unique identifiers for locations of providers with the unique identifier of the store. If the presence communication server 104 finds a match, then the presence communication server 104 may notify the consumer who registered the indication of interest for the store. In some embodiments, the presence communication server 104 may automatically establish a presence communication between the provider and the consumer after both parties have consented to the presence communication.

A consumer may have a presence communication with a provider at a location such as a store. The consumer may be interested in knowing if the store has a particular product in stock. The consumer may transmit an identifier of the particular product (for example, a SKU, a UPC code, a product identifier, an image of the product, or an identifier generated from an image of the product) to the provider. The presence communication client 108 of the provider may receive the identifier. As the provider is capturing video, the presence communication client 108 may compare the received identifier with identifiers in the captured video or that the presence communication client 108 generates based on images or video that the provider captures. If the presence communication client 108 determines that there is a match, the presence communication client 108 may automatically notify the consumer that the particular product is in stock.

### Privacy and Security

The presence communication system may enforce zero trust for the information shared using, among other things, the following approach. First, the presence communication system may ensure privacy and filter illegal, abusive, or undesirable requests from consumers. Second, the presence communication system may selectively blur or not blur items captured in video (for example, clutter).

In some embodiments, there are three phases of blurring that the presence communication client 108 may perform. In a first phase, the presence communication client 108 may blur everything by default, and the provider may have to affirmatively select what to unblur, either the entire video or a portion of the video. In a second phase, the presence communication client 108 may include one or more artificial intelligence or machine learning models that are trained on the types of items to blur or not blur. While the provider is capturing video, the presence communication client 108 may apply the one or more artificial intelligence or machine learning models to detect items and either blur them or not blur them.

In a third phase, the presence communication client 108 may perform encryption-based blurring. For example, the presence communication client 108 may encrypt video using an encryption algorithm. This may facilitate different people seeing different things. For example, the presence communication client 108 of the provider may encrypt faces or other personally identifiable information with a public key (of a public key-private key pair) so that only a holder of the corresponding private key can see the decoded faces or other personally identifiable information. An example may be the following. A provider may capture video of a car license plate. The presence communication client 108 may encrypt the license plate in such a fashion that only the owner of the car can see the license plate in the video. In such a situation, the consumer (owner of the car) may have provided the provider with the public key of the consumer’s public key-private key pair so that the presence communication client 108 of the provider may utilize the public key to encrypt the video.

As another example, a provider may capture video of a group of children. The video sent to a consumer will have all the faces of the children blurred unless the consumer has proved that one of the children is his or her child or that the consumer has a valid reason to see the child’s face. The presence communication client 108 of the consumer may detect the blurred video, recognize that the blurred video is encrypted, and decrypt the blurred with the private key. In such a situation, the consumer (parent of the child) may have provided the provider with the public key of the consumer’s public key-private key pair so that the presence communication client 108 may utilize the public key to encrypt the video. Other examples are possible.

FIG. 16 is a flow diagram depicting a method 1600 for encrypting video in some embodiments. The method 1600 may be performed by the presence communication client 108 of the provider. At step 1602 the presence communication client 108 of the provider may receive a request from the presence communication client 108 of the consumer to capture video in a presence communication. At step 1604 the presence communication client 108 of the provider may receive an encryption key from the presence communication client 108 of the consumer. At step 1606 the presence communication client 108 of the provider may encrypt a portion of the video using the encryption key to the presence communication client 108 of the consumer. At step 1608 the presence communication client 108 of the provider may transmit the video to the presence communication client 108 of the consumer.

### Circle of Trust

A user of the presence communication system may add or remove connections with other users of the presence communication system. For example, a user may utilize the circle of trust (CoT) button 416 (see FIG. 4A) to add or remove connections with other users. The user may establish one or more trusted groups of one or more connected users. In some embodiments, the users with which a user has a connection may be able to see the user’s location, even though the location may not be visible to other users of the presence communication system. For example, the user may establish a trusted group of the user’s family members or friends. The presence communication server 104 may allow the user’s family members or friends in the trusted group to see the user’s location on a map interface, such as the map 404 (see FIG. 4A). However, the user may not see the locations of the user’s family members or friends unless such family members or friends add the user to trusted groups of their own.

However, a user may wish that his or her location be hidden from other users in his or her groups, while still being available to provide location-based services. The presence communication server 104 may allow the user to hide his or her location from other users on the map 404 while still maintaining his or her availability to provide location-based services. For example, using the interface 400 the user may select menu button 420 to access his or her profile. The user may then toggle his or her visibility on or off, which may show or hide the user’s location on the map 404. In some embodiments, the user may control his or her visibility on a user or group of users basis. The user may also toggle his or her availability to provide location-based services on or off. One advantage of this approach is that it allows the user to control his or her visibility for privacy reasons. The user may not be visible to other users who are exploring or browsing users by location but may be visible in response to requests for location-based services (for example, a request for a photographer in Hawaii).

In some embodiments, the presence communication system enforces a requirement that a group of users must have a minimum size (for example, ten members) in order for any user to see the location of any member of the group. The presence communication system may enforce this requirement to reduce or prevent the likelihood of any one user tracking the location of any other user in the group. The presence communication system may make this minimum size adjustable to users on a per group basis. Users can always change their visibility so that they may not be seen on a map interface while still maintaining their availability to provide services, including location-based services.

### Virtual World Tours

Items or locations in the real-world (for example, Machu Picchu) may have unique identifiers in the presence communication system. In some embodiments, the presence communication system may treat such items or locations as expertises and give them expertise identifiers. The presence communication server 104 may store images, video, audio, descriptions, 3D representations, or other information about the data for the items or locations. Such items or locations may be searched for by users. Upon selection of an item or location by a consumer, the presence communication server 104 may provide the images, video, audio, descriptions, 3D representations, or other information to the consumer.

A provider may generate content for a location, and the provider may be compensated when a consumer accesses the content. Additionally or alternatively, the presence communication server 104 may generate (for example, using one or more artificial intelligence or machine learning systems) or obtain content for locations and provide the content to consumers. The presence communication server 104 may thus create a knowledge hub of the entire world that is accessible to anyone, so as to allow anyone to go on a virtual tour of any location in the world.

In some embodiments, an item or location is associated with one or more providers, who may have expertise in the item or the location. Upon selection of the item or location by a consumer, the presence communication server 104 may establish a presence communication between the consumer and one of the providers. The provider may then provide services related to the item or location to the consumer. In some embodiments, the provider may refer the consumer to another provider, and the presence communication server 104 may facilitate the establishment of another presence communication with the other provider. In such cases, the original provider may be provided with a portion of the revenue earned by the other provider as a referral fee.

### Recommendations

When a consumer is in a presence communication with a provider, the presence communication system may make recommendations to the consumer regarding other presence communications that the consumer may be interested in. For example, consider a presence communication where a provider is providing a service to a consumer at a store in one department of the store. The presence communication client 108 of the provider, which has a history of the provider’s presence communication, may determine that the provider has also provided other presence communications in other departments of the store, and infer that the consumer may be interested in the other departments. The presence communication client 108 of the provider may provide a recommendation to the presence communication client 108 of the consumer that the consumer should obtain a service in one of the other departments. If the consumer accepts the recommendation, the provider may be able to extend the presence communication or have a new presence communication established with the consumer in one of the other departments. Alternatively, the consumer may be transferred to another provider, such as another trusted provider or a provider in a Circle of Trust (CoT) of the original provider. In such cases, the original provider may be provided with a portion of the revenue earned by the other provider as a referral fee.

### Lend an Ear

Existing communication platforms either compromise privacy (through identity exposure or digital recording) or fail to provide safe, stigma-free spaces for individuals to express sensitive concerns. Social media often amplifies judgment and anxiety rather than alleviating them. There is a need for a technology that preserves trust and anonymity while enabling meaningful human connection across geographies.

In some embodiments, the presence communication system enables instant, trusted, and anonymous human-to-human interaction without digital recording or identity disclosure. The presence communication system allows users to connect with other individuals based on filters such as location, skills, or expertise, while ensuring privacy and trust. The presence communication system provides a structured way for individuals to share personal, emotional, or sensitive thoughts with another trusted human listener, thereby improving mental health and reducing social stigma barriers.

In various embodiments, the presence communication system provides the following features: anonymous real-time connection, where a user may initiate instant communication with another user without revealing his or her identity, while the presence communication system ensures no digital recording of the interaction occurs; contextual filtering, where users may filter potential human connections by location, expertise, or skill set to address specific needs (e.g., legal advice, emotional support, technical help); a trusted provider pool, where a network of verified but anonymous trusted providers who can offer listening or guidance services may be accessible to users who need support or assistance; and a dedicated mode that allows a user to connect with another human for the sole purpose of being listened to, without judgment, advice, or social repercussions. These features of the presence communication system assist in addressing mental health needs such as coping with breakups, family or workplace conflicts, or personal anxieties. The presence communication system may have mental health applications by enabling safe expression and human empathy. Accordingly, the presence communication system may reduce or eliminate isolation, stigma, self-harm or suicidal thoughts or tendencies, and stress, while providing scalable, human-centered support.

There are several advantages to these approaches, namely the presence communication system may: preserve privacy and anonymity while allowing contextual connection; ensure that there are no digital traces of the substance of the communication, thereby reducing or eliminating risks of exposure; provide mental health benefits by enabling stigma-free expression and emotional relief; and unlock a global human presence network, accessible anywhere and anytime to anyone. Other advantages will be apparent.

### Supplementing or Complementing Chatbot Information

An interactive online chatbot, which may also be referred to as an artificial intelligence (AI) bot, may be a computer program that is designed to simulate human conversation through text or voice interactions. A chatbot may utilize AI or machine learning (ML) models, such as natural language processing (NLP) models, to understand and respond to user input. Chatbots are often integrated into websites, applications, or messaging platforms, where they provide automated customer support, answer frequently asked questions, or guide users through processes. Chatbots range from simple rule-based systems that follow predefined scripts to advanced agents that learn and adapt through machine learning. Examples of chatbots are, without limitation, ChatGPT of OpenAI Global, LLC; MetaAI of Meta Platforms, Inc.; and Gemini of Google LLC.

Although useful, even the most advanced chatbots exhibit several key deficiencies. Chatbots often misinterpret input and thus provide irrelevant responses. Chatbots also have difficulty understanding context and maintaining long-term memory within a conversation, making it difficult to maintain consistent and meaningful interactions. Moreover, chatbots generally exhibit gaps in common sense reasoning and real-world knowledge, which may hinder their ability to handle unexpected or ambiguous user queries. Furthermore, chatbots can sometimes generate factually incorrect or nonsensical information, particularly when dealing with topics outside their training data. Even when delivering factually correct information, chatbot responses on many topics may be of a very general nature, lacking the detail or nuance that a user might desire. On a fundamental level, chatbots are unable to access human knowledge that is not part of their training data.

The presence communication system may overcome the deficiencies of chatbots and provide other advantages. The presence communication system may allow users to provide services that supplement or complement chatbot responses. The additional information system may analyze the input that users provide to chatbots and the responses of the chatbots. The presence communication system may identify users who may provide time, experience, or skills that are relevant to the input or the responses. Such time, experience, or skills may be particularly useful to chatbot users. The presence communication system may then connect the chatbot users with the identified users. This allows the chatbot users to potentially obtain information and insight beyond what can be provided by chatbots. The presence communication system may also allow users to provide time, experience, or skills that supplement or complement non-chatbot information, such as information on websites provided by humans, information in applications or other websites, and search results.

The presence communication system may facilitate providers providing their time, experiences, or skills to supplement or complement information generated by AI programs, such as chatbots, to consumers. As an illustrative and non-limiting example, a consumer may provide input to a chatbot and receive information from the chatbot in response to the input. The presence communication system may analyze the input or the information and provide the consumer with the ability to connect with a provider who may provide services relevant to the input or the information. For example, a consumer may have provided an input to a chatbot asking for advice as to where a person with small children moving from New York to the San Francisco Bay Area in California should rent a home given that the person will work in Mountain View, California. The chatbot may have provided seven cities as options, as well as four factors to consider in choosing a place to rent. Although the chatbot response provides several options, a consumer who is unfamiliar with the seven cities may be left with questions that the chatbot may be unable to answer (for example, what exactly are the differences between a “decent school,” a “good school,” and an “excellent school”?).

The presence communication system may analyze the input and the chatbot response, identify providers who are able to provide services relevant to the input or the chatbot response, and provide the inquiring consumer with links to the identified providers. If selected by the consumer, the presence communication system may connect the consumer with the corresponding one or more providers. In some embodiments, the provider may be verified by the presence communication system, that the connection between the consumer and the provider may be private, the consumer and the provider may be expected to follow certain rules, and that the anonymity of both the consumer and the provider may be preserved by the presence communication system.

In connecting the consumer with the provider, the presence communication system may facilitate the provider providing information or other services that are relevant to or of interest to the consumer.. For example, the consumer may have interest in a particular city, such as Fremont, California. The consumer may have questions about a particular Fremont neighborhood, Fremont schools, or activities in Fremont. The provider may be able to give insightful answers to the consumer’s questions that the chatbot cannot give, and do so in a way that takes less time than would take if the consumer were to ask follow-on questions of the chatbot. Accordingly, the presence communication system may allow for the consumer to obtain better information in a more efficient way. The consumer benefits by a better experience and the provider benefits by being compensated for providing his or her services.

The presence communication system may use frequency matching to match the consumer with one or more providers. Accordingly, the provider may match consumers with providers with similar backgrounds, temperaments, abilities and/or other affinity factors. For example, the presence communication system may identify a provider that has one or more of the following attributes in common with the consumer: 1) lives or has lived in New York; 2) has or had small children; 3) works or has worked in Mountain View; and 4) rents or has rented. In such a fashion, the presence communication system may identify one or more providers that can provide the most relevant information to the consumer.

Additionally or alternatively, the presence communication system may identify the one or more providers utilizing other factors. One factor is an estimation of the trust that a consumer may have in a provider. For example, the consumer may be more likely to trust providers with whom the consumer has one or more other persons in common. Accordingly, the presence communication system may prioritize such providers. Another factor is consumer-provided ratings of providers. Other factors will be apparent.

In some embodiments, the presence communication system identifies the one or more providers based on information (for example, provider information relevant to the input or the chatbot response) the presence communication system has about the one or more providers, and additionally with regard to only the availability of each of the one or more providers. That is, the presence communication system may assume that the identified one or more providers may provide services to the consumer if each of the one or more providers has indicated that he or she is available to provide services. In some embodiments, in addition to provider information and provider availability, the presence communication system may provide the consumer input or the chatbot response (or information derived therefrom, such as summaries) to one or more prospective providers to gauge both their expertise and their interests in responding to the consumer. Each of the one or more prospective providers may thus indicate his or her interest in responding to the consumer. Doing so would thus allow each of the one or more prospective providers to have a sense of what the consumer is interested in prior to indicating his or her interest in helping the consumer. Accordingly, the presence communication system may take provider relevance, availability, and interest into account in identifying the one or more providers to provide services to the consumer.

The presence communication system may provide consumers with the ability to connect with providers not only on chatbot websites or applications but also on other websites or applications where information is provided. As an example, an information system 114 may provide search results in response to search queries. The presence communication system may analyze the search query or the search results, identify providers that may provide information relevant to the search query or the search results, and provide links that connect the consumers with the identified providers. As another example, the presence communication system may provide links to providers on websites or applications provided by the information system 114. Such websites or applications may include websites or applications where users work collaboratively, such as word processing software, design and publishing websites, collaborative design websites, and other websites or applications. Other examples will be apparent.

The presence communication system may provide one or more application programming interfaces (APIs) that websites or applications may use to interact with the presence communication system to provide the described functionality to users of the websites or applications. The one or more APIs may facilitate additional functionality. In certain cases, a user of another website or application may not be a user of the presence communication system at the time of his or her request that the presence communication system connect him or her to a provider. The presence communication system may direct the user to a sign-up process prior to connecting him or her to the provider. In some embodiments, the presence communication system may require the user to be approved by an existing user of the presence communication system prior to being allowed to become a user of the presence communication system.

The presence communication system may facilitate connections to providers who can provide services in various areas, such as real estate, communications, entertainment, education, e-commerce, healthcare, and travel. For example, the presence communication system may facilitate connections to providers that have information regarding travel destinations in which consumers may be interested. As another example, the presence communication system may facilitate connections to providers that have information regarding colleges or universities, such as students or professors. Such providers may be able to advise consumers on the colleges or universities that they attend, which may be of use to prospective students looking to learn more about the colleges or universities. As another example, the presence communication system may facilitate connections to providers who may be able to advise consumers on retail products or services. It will be apparent that there are numerous use cases for the functionality of the presence communication system described herein, and that the presence communication system is not limited to the described use cases.

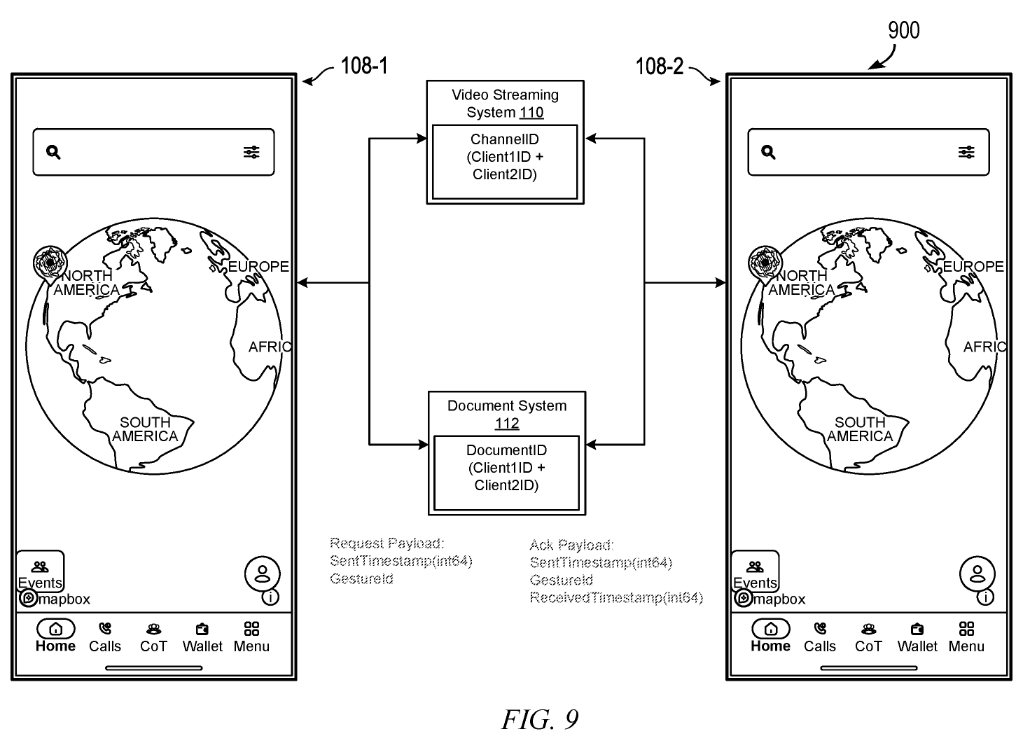

FIG. 9 is a diagram 900 depicting communication between two presence communication clients according to some embodiments. A first presence communication client 108-1 may transmit video to the video streaming system 110. The video streaming system 110 may assign the video an identifier (ChannelID) that is a function of a first identifier of the first presence communication client 108-1 (Client1ID) and a second identifier of the second presence communication client 108-2 (Client2ID). As the video streaming system 110 may receive and transmit numerous videos for numerous pairs of presence communication clients, the video identifier allows the video streaming system 110 to transmit the correct video to the correct presence communication client. The video streaming system 110 may transmit the video to the second presence communication client 108-2.

The diagram 900 also depicts that the first presence communication client 108-1 and the second presence communication client 108-2 may transmit instructions, messages, or responses to each other through the document system 112. The document system 112 may create a document for the presence communication between the first presence communication client 108-1 and the second presence communication client 108-2 and assign the document an identifier (DocumentID) that is a function of the first identifier of the first presence communication client 108-1 (Client1ID) and the second identifier of the second presence communication client 108-2 (Client2ID). For example, if the first presence communication client 108-1 sends a response indicating that the provider cannot move forward, which may have a gesture identifier (GestureID), the document system 112 may write the gesture identifier to the document and send the gesture identifier to the second presence communication client 108-2, which may then audibly output a message corresponding to the GestureID.

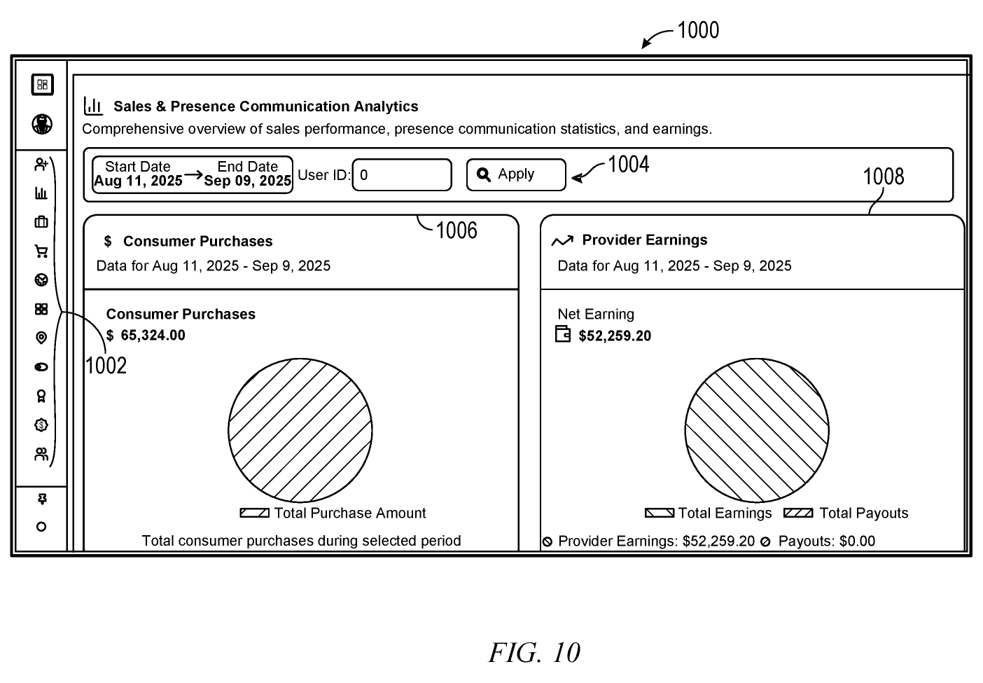

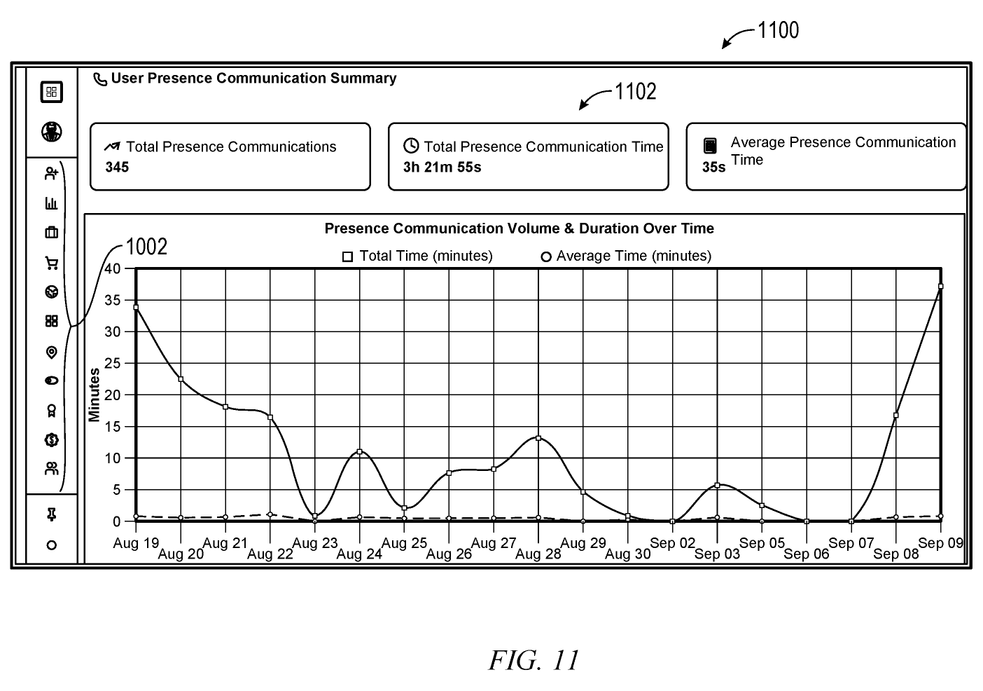

FIGS. 10 and 11 depict example interfaces that may be provided by the presence communication server 104 to provide analytic outputs relating to presence communications or the presence communication system in some embodiments. FIG. 10 depicts an interface 1000 that displays an analytic output 1006 relating to consumer purchases and an analytic output 1008 relating to provider earnings. A user of the interface 1000 may specify a time period for the analytic output 1006 or the analytic output 1008 using the user interface elements 1004. The interface 1000 also includes menu items 1002 for selecting other analytic outputs that the presence communication server 104 may provide. FIG. 11 depicts an interface 1100 that displays an analytic output 1102 relating to the total number of presence communications over a time period, the total time of the presence communications of the time period, and an average time of the presence communications.

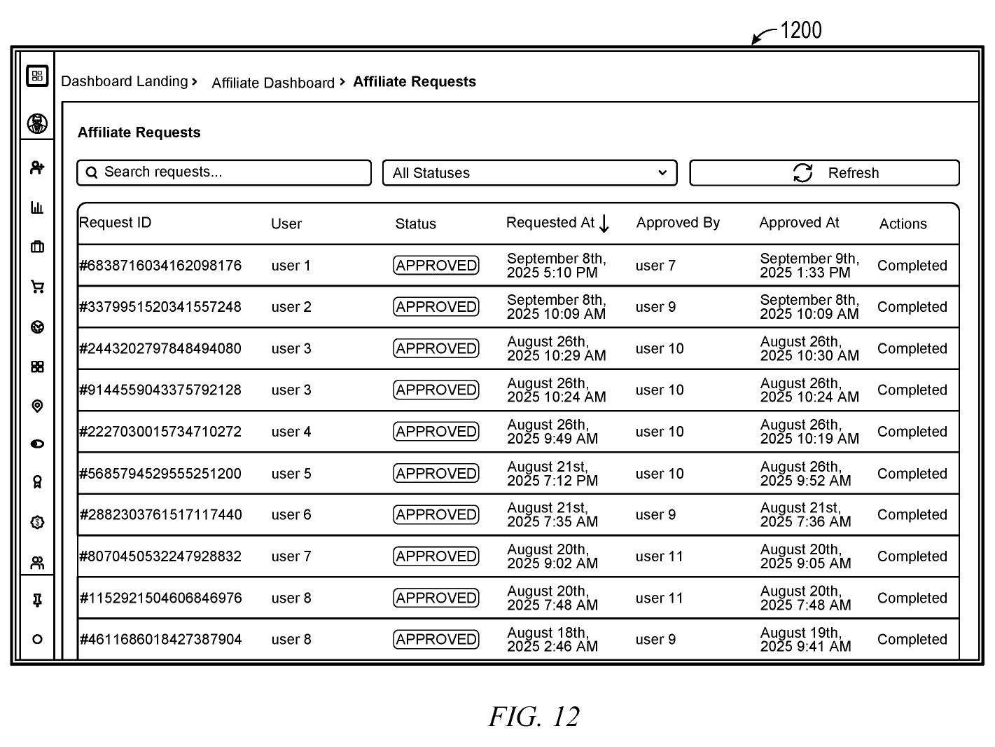

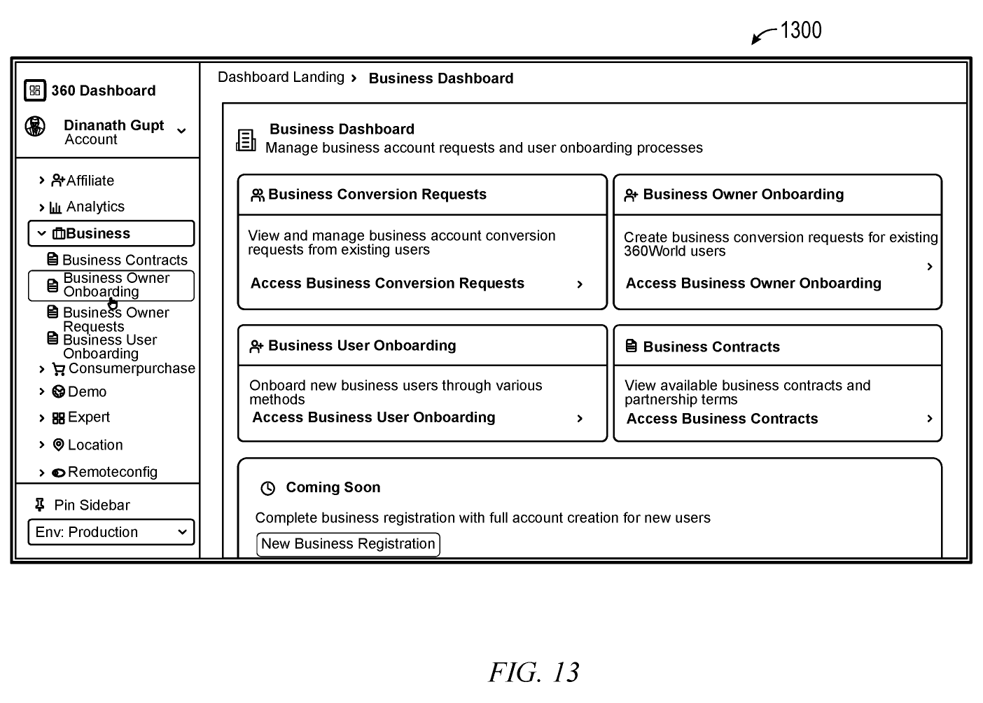

FIGS. 12 and 13 depict example interfaces that may be provided by the presence communication server to provide functionality relating to managing affiliates and managing business accounts according to some embodiments. FIG. 12 depicts an interface 1200 that a user of the presence communication server 104 may utilize to view and approve requests by users to become affiliates in the presence communication system. FIG. 13 depicts an interface 1300 that the user may use to manage business account requests and user onboarding processes.

FIG. 14 depicts a block diagram of an example digital device 1400 according to some embodiments. The digital device 1400 is shown in the form of a general-purpose computing device. The digital device 1400 includes at least one processor 1402, which may be or include one or more central processing units (CPUs) or one or more graphics processing units (GPUs), random access memory (RAM 1404), communication interface 1406, input/output device 1408, storage 1410, and a system bus 1412 that couples various system components including storage 1410 to the at least one processor 1402. A set (which may be a physical set or a logical set) of one or more of the digital devices 1400 may be referred to as a computing system.

System bus 1412 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The digital device 1400 typically includes a variety of computer system readable media, such as computer system readable storage media. Such media may be any available media that is accessible by any of the systems described herein and it includes both volatile and nonvolatile media, removable and non-removable media.

In some embodiments, the at least one processor 1402 is configured to execute executable instructions (for example, programs). In some embodiments, the at least one processor 1402 comprises circuitry or any processor capable of processing the executable instructions.

In some embodiments, RAM 1404 stores programs or data. In various embodiments, working data is stored within RAM 1404. The data within RAM 1404 may be cleared or ultimately transferred to storage 1410, such as prior to reset or powering down the digital device 1400.

In some embodiments, the digital device 1400 is coupled to a network via communication interface 1406. The digital device 1400 can communicate with one or more networks such as a local area network (LAN), a general wide area network (WAN), or a public network (for example, the Internet).

In some embodiments, input/output device 1408 is any device that inputs data (for example, mouse, keyboard, stylus, sensors, etc.) or outputs data (for example, speaker, display, virtual reality headset).

In some embodiments, storage 1410 can include computer system readable media in the form of non-volatile memory, such as read only memory (ROM), programmable read only memory (PROM), solid-state drives (SSD), flash memory, or cache memory. Storage 1410 may further include other removable/non-removable, volatile/non-volatile computer system storage media. By way of example only, storage 1410 can be provided for reading from and writing to a non-removable, non-volatile magnetic media. The storage 1410 may include a non-transitory computer-readable medium, or multiple non-transitory computer-readable media, which stores programs or applications for performing functions such as those described herein. Although not shown, a magnetic disk drive for reading from and writing to a removable, non-volatile magnetic disk (for example, a “floppy disk”), and an optical disk drive for reading from or writing to a removable, non-volatile optical disk such as a CDROM, DVD-ROM or other optical media can be provided. In such instances, each can be connected to system bus 1412 by one or more data media interfaces. As will be further depicted and described below, storage 1410 may include at least one program product having a set (for example, at least one) of program modules that are configured to carry out the functions of embodiments of the technology. In some embodiments, RAM 1404 is found within storage 1410.

Programs/utilities, having a set (at least one) of program modules may be stored in storage 1410 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions or methodologies of embodiments of the technology as described herein.

It should be understood that although not shown, other hardware or software components could be used in conjunction with the digital device 1400. Examples include, but are not limited to microcode, device drivers, redundant processing units, and external disk drive arrays, RAID systems, tape drives, and data archival storage systems, etc.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure.

It will be appreciated that aspects of one or more embodiments may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a circuit, module or system. Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a solid state drive (SSD), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program or data for use by or in connection with an instruction execution system, apparatus, or device.

A transitory computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present technology may be written in any combination of one or more programming languages, including an object-oriented programming language such as Java, Smalltalk, C++, Python, or the like and conventional procedural programming languages, such as the C programming language or similar programming languages. The computer program code may execute entirely on any of the systems described herein or on any combination of the systems described herein.

Aspects of the present technology may be described with reference to flowchart illustrations or block diagrams of methods, apparatus (systems) and computer program products according to embodiments of the technology. It will be understood that each block of the flowchart illustrations or block diagrams, and combinations of blocks in the flowchart illustrations or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart or block diagram block or blocks.

While particular elements, embodiments and applications have been shown and described, it will be understood, of course, that the claims are not limited thereto since modifications may be made by those skilled in the art without departing from the spirit and scope of the present disclosure, particularly in light of the foregoing teachings. Such modifications are to be considered within the purview and scope of the claims appended hereto.

While specific examples are described above for illustrative purposes, various equivalent modifications are possible. For example, while processes or blocks are presented in a given order, alternative implementations may perform routines having steps, or employ systems having blocks, in a different order, and some processes or blocks may be deleted, moved, added, subdivided, combined, or modified to provide alternative or sub-combinations. Each of these processes or blocks may be implemented in a variety of different ways. Also, while processes or blocks are at times shown as being performed in series, these processes or blocks may instead be performed or implemented concurrently or in parallel or may be performed at different times. Further any specific numbers noted herein are only examples: alternative implementations may employ differing values or ranges.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Furthermore, any specific numbers noted herein are only examples: alternative implementations may employ differing values or ranges.

Components may be described or illustrated as contained within or connected with other components. Such descriptions or illustrations are only examples, and other configurations may achieve the same or similar functionality. Components may be described or illustrated as “coupled,” “couplable,” “operably coupled,” “communicably coupled” and the like to other components. Such description or illustration should be understood as indicating that such components may cooperate or interact with each other, and may be in direct or indirect physical, electrical, or communicative contact with each other.

Components may be described or illustrated as “configured to,” “adapted to,” “operative to,” “configurable to,” “adaptable to,” “operable to” and the like. Such description or illustration should be understood to encompass components both in an active state and in an inactive or standby state unless required otherwise by context.

The use of “or” in this disclosure is not intended to be understood as an exclusive “or.” Rather, “or” is to be understood as including “and/or.” For example, the phrase “providing products or services” is intended to be understood as having several meanings: “providing products,” “providing services,” and “providing products and services.”

Headings in this application may be provided for organization and may not necessarily be used to interpret or constrain the purview and scope of the claims appended hereto. Moreover, concepts or features of technologies described under a particular heading may be used in technologies described under other headings. Accordingly, technologies described under a particular heading are not limited to the concepts or features described under that particular heading.

It may be apparent that various modifications may be made, and other embodiments may be used without departing from the broader scope of the discussion herein. Therefore, these and other variations upon the example embodiments are intended to be covered by the disclosure herein.

1. A method comprising:
receiving, from multiple first presence communication clients, multiple first availabilities and multiple first locations;
providing at least some of the multiple first availabilities and the multiple first locations to a second presence communication client;
receiving, from the second presence communication client, a first request for one or more services at a particular location;
identifying, based on the first request, one or more first presence communication clients from the multiple first presence communication clients;
selecting, from the one or more first presence communication clients, a particular first presence communication client;
transmitting to the particular first presence communication client a second request to establish a presence communication with the second presence communication client;
receiving from the particular first presence communication client an acceptance of the second request; and
establishing the presence communication between the particular first presence communication client and the second presence communication client,
wherein, during the presence communication, only the particular first presence communication client transmits video to the second presence communication client,
the second presence communication client may transmit instructions from a limited set of instructions to the particular first presence communication client, and
the particular first presence communication client may transmit responses from a limited set of responses to the second presence communication client.

2. The method of claim 1 wherein the presence communication is a first presence communication, the particular first presence communication client is a first particular first presence communication client, the acceptance is a first acceptance, and further comprising:
determining that the particular first presence communication client has ended the first presence communication;
selecting, from the one or more first presence communication clients, a second particular first presence communication client;
transmitting to the second particular first presence communication client a third request to establish a second presence communication with the second presence communication client;
receiving from the second particular first presence communication client a second acceptance of the third request; and
establishing the second presence communication between the second particular first presence communication client and the second presence communication client.

3. The method of claim 1 wherein the second presence communication client has an association with the particular first presence communication client that was created prior to the presence communication.

4. The method of claim 1 wherein the presence communication includes video captured by the particular first presence communication client, a portion of the video encrypted by the particular first presence communication client, transmitted by the particular first presence communication client to the second presence communication client, and displayed by the second presence communication client after decryption of the portion of the video.

5. The method of claim 1wherein the presence communication further includes one or more first instructions from the limited set of instructions received by the second presence communication client, transmitted by the second presence communication client to the particular first presence communication client, and the particular first presence communication client generates, based on the one or more first instructions, one or more second instructions, and outputs the one or more second instructions.

6. The method of claim 1, further comprising:
storing a start and an end of the presence communication;
determining, based on the start and the end of the presence communication, a first amount to credit a first account associated with a first user of the particular first presence communication client and a second amount to debit a second account associated with a second user of the second presence communication client;
crediting the first account by the first amount; and
debiting the second account by the second amount.

7. One or more non-transitory computer-readable media comprising executable instructions that when executed by one or more processors of a system cause the system to perform a method comprising:
receiving, from multiple first presence communication clients, multiple first availabilities and multiple first locations;
providing at least some of the multiple first availabilities and the multiple first locations to a second presence communication client;
receiving, from the second presence communication client, a first request for one or more services at a particular location;
identifying, based on the first request, one or more first presence communication clients from the multiple first presence communication clients;
selecting, from the one or more first presence communication clients, a particular first presence communication client;
transmitting to the particular first presence communication client a second request to establish a presence communication with the second presence communication client;
receiving from the particular first presence communication client an acceptance of the second request; and
establishing the presence communication between the particular first presence communication client and the second presence communication client,
wherein, during the presence communication, only the particular first presence communication client transmits video to the second presence communication client,
the second presence communication client may transmit instructions from a limited set of instructions to the particular first presence communication client, and
the particular first presence communication client may transmit responses from a limited set of responses to the second presence communication client.

8. The one or more non-transitory computer-readable media of claim 7 wherein the presence communication is a first presence communication, the particular first presence communication client is a first particular first presence communication client, the acceptance is a first acceptance, and the method further comprising:
determining that the particular first presence communication client has ended the first presence communication;
selecting, from the one or more first presence communication clients, a second particular first presence communication client;
transmitting to the second particular first presence communication client a third request to establish a second presence communication with the second presence communication client;
receiving from the second particular first presence communication client a second acceptance of the third request; and
establishing the second presence communication between the second particular first presence communication client and the second presence communication client.

9. The one or more non-transitory computer-readable media of claim 7 wherein the second presence communication client has an association with the particular first presence communication client that was created prior to the presence communication.

10. The one or more non-transitory computer-readable media of claim 7 wherein the presence communication includes video captured by the particular first presence communication client, a portion of the video encrypted by the particular first presence communication client, transmitted by the particular first presence communication client to the second presence communication client, and displayed by the second presence communication client after decryption of the portion of the video.

11. The one or more non-transitory computer-readable media of claim 7 wherein the presence communication further includes one or more first instructions from the limited set of instructions received by the second presence communication client, transmitted by the second presence communication client to the particular first presence communication client, and the particular first presence communication client generates, based on the one or more first instructions, one or more second instructions, and outputs the one or more second instructions.

12. The one or more non-transitory computer-readable media of claim 7, the method further comprising:
storing a start and an end of the presence communication;
determining, based on the start and the end of the presence communication, a first amount to credit a first account associated with a first user of the particular first presence communication client and a second amount to debit a second account associated with a second user of the second presence communication client;
crediting the first account by the first amount; and
debiting the second account by the second amount.

13. A system comprising:
multiple first presence communication clients configured to transmit multiple first availabilities and multiple first locations;
a second presence communication client; and
a presence communication server configured to:
receive the multiple first availabilities and the multiple first locations, and
provide at least some of the multiple first availabilities and the multiple first locations to the second presence communication client,
wherein the second presence communication client is configured to:
receive at least some of the multiple first availabilities and the multiple first locations, and
transmit a first request for one or more services at a particular location,
the presence communication server is further configured to:
receive the first request for the one or more services at the particular location,
identify, based on the first request, one or more first presence communication clients from the multiple first presence communication clients,
select, from the one or more first presence communication clients, a particular first presence communication client,
transmit to the particular first presence communication client a second request to establish a presence communication with the second presence communication client,
receive from the particular first presence communication client an acceptance of the second request, and
establish the presence communication between the particular first presence communication client and the second presence communication client, and
the particular first presence communication client is configured to:
capture video; and
transmit the video to the second presence communication client, wherein, during the presence communication, only the particular first presence communication client captures video and transmits the video to the second presence communication client,
the second presence communication client is further configured to transmit instructions from a limited set of instructions to the particular first presence communication client, and
the particular first presence communication client is further configured to transmit responses from a limited set of responses to the second presence communication client.

14. The system of claim 13 wherein the second presence communication client is further configured to:
receive the video,
display the video,
receive, via a gesture user interface, one or more first instructions from the limited set of instructions, and
transmit the one or more first instructions to the particular first presence communication client, and
the particular first presence communication client is further configured to:
receive the one or more first instructions,
generate, based on the one or more first instructions, one or more second instructions, and
output the one or more second instructions.

15. The system of claim 14 wherein the particular first presence communication client is associated with a language, to generate the one or more second instructions includes to generate the one or more second instructions in the language, and to output the one or more second instructions includes to audibly output the one or more second instructions in the language.

16. The system of claim 13 wherein the particular first presence communication client is configured to:
capture video, the video including a product,
and transmit the video to the second presence communication client,
the second presence communication client is further configured to:
receive the video,
display the video,
receive a selection of the product,
transmit a query for the product,
receive results for the query, and
display at least some of the results, and
the particular first presence communication client is further configured to:
receive the results, and
display at least some of the results.

17. The system of claim 13 wherein the presence communication includes video, and the particular first presence communication client is configured to:
receive a selection of a portion of the video to blur,
blur the portion of the video, and
transmit the video, including the portion of the video that is blurred or a blurred representation of the portion of the video, to the second presence communication client, and
the second presence communication client is further configured to:
receive the video, including the portion of the video that is blurred or a blurred representation of the portion of the video, and
display the video, including the portion of the video that is blurred or the blurred representation of the portion of the video.

18. The system of claim 13 wherein the particular first presence communication client is configured to transmit a first message to the second presence communication client, and the second presence communication client is further configured to:
receive the first message,
provide the first message for processing by one or more artificial intelligence or machine learning systems,
receive a second message, based on processing of the first message by the one or more artificial intelligence or machine learning systems, and
output the second message.

19. The system of claim 13 wherein the particular first presence communication client is configured to:
capture video, the video including an item,
determine that the item should be blurred in the video,
blur the item in the video or generate a blurred representation of the item,
generate a first identifier for the item, and
transmit the video, including the item that is blurred, or the blurred representation of the item, and the first identifier to the second presence communication client, and
the second presence communication client is further configured to:
receive the video, including the item that is blurred, or the blurred representation of the item, and the first identifier,
determine that the first identifier matches a second identifier stored by the second presence communication client, and
unblur the item that is blurred in the video or the blurred representation of the item, and
display the video, including the item.

20. The system of claim 19 wherein the item that is blurred includes a part of a person or other identifiable information of the person.
